(19) United States
(12) Patent Application Publication
(10) Pub. No.: US 2018/0137461 A1
(43) Pub. Date: May 17, 2018

(54) ENTERPRISE-ACCESSIBLE CUSTOMER LOCKER

(71) Applicant: Wal-Mart Stores, Inc., Bentonville, AR (US)

(72) Inventors: Bruce W. Wilkinson, Rogers, AR (US); Todd D. Mattingly, Bentonville, AR (US); Donald R. High, Noel, MO (US)

(21) Appl. No.: 15/783,960

(22) Filed: Oct. 13, 2017

Related U.S. Application Data
(60) Provisional application No. 62/422,837, filed on Nov. 16, 2016.
(60) Provisional application No. 62/542,896, filed on Aug. 9, 2017.
(60) Provisional application No. 62/523,148, filed on Jun. 21, 2017.
(60) Provisional application No. 62/467,999, filed on Mar. 7, 2017.
(60) Provisional application No. 62/436,842, filed on Dec. 20, 2016.
(60) Provisional application No. 62/485,045, filed on Apr. 13, 2017.

(51) Int. Cl. G06Q 10/08; G06Q 20/18

(52) U.S. Cl. CPC G06Q 10/0836; G06Q 20/18

(57) ABSTRACT

An enterprise-accessible customer locker is physically located at a first customer's address. A control circuit can be configured to select products (including unordered products if desired) for a first customer to be placed in the aforementioned enterprise-accessible customer locker. The control circuit can also be configured to determine a need to deliver a particular product to a second customer who is physically discrete from the aforementioned first customer's address. The control circuit can then be further configured to arrange to transfer the particular product from the first customer's enterprise-accessible customer locker to the second customer at a delivery address corresponding to the second customer. By one approach, the foregoing can include a consideration of whether the particular product is in fact available at the first customer's enterprise-accessible customer locker and/or what the relevant timeframe is for when the first customer may in fact need the particular product.

### RELATED APPLICATION(S)

This application claims the benefit of U.S. Provisional Application No. 62/542,896, filed Aug. 9, 2017, U.S. Provisional Application No. 62/523,148, filed Jun. 21, 2017, U.S. Provisional Application No. 62/467,999, filed Mar. 7, 2017, U.S. Provisional Application No. 62/422,837, filed Nov. 16, 2016, U.S. Provisional Application No. 62/436,842, filed Dec. 20, 2016, and U.S. Provisional Application No. 62/485,045, filed Apr. 13, 2017, all of which are incorporated herein by reference in their entirety.

### TECHNICAL FIELD

These teachings relate generally to pre-positioned products.

### BACKGROUND

Traditionally, a retail storefront is the side of a physical retail store that faces a point of pedestrian access (such as a sidewalk, street, mall pathway, and so forth) and may (or may not) have one or more windows to offer potential customers a (possibly organized) view of one or more products that are available for retail sale at the store. As used herein it will be understood that a retail storefront is not a mere facade but in fact offers a customer physical access to products being offered for retail sale within the store.

Though a successful shopping paradigm for millennia, many consumers are preferring delivery services that avoid a need to physically visit a retail store. Unfortunately, using a delivery service in this context inherently necessitates some delay between initiating the retail transaction and taking delivery of the product being purchased. This delay may be days or even weeks in some cases. Some retailers are striving to reduce that delay to only a few hours, but even that amount of delay may be unacceptable to some consumers at least some of the time.

That said, holding down costs is also of paramount importance. Storage of unsold items represents one important cost point. In particular, warehouses, distribution centers, and storerooms all require a myriad of related expenses. Notwithstanding that such facilities as a modern distribution center are well designed and efficiently operated, those facilities nevertheless require costly space, utilities, personnel, and so forth.

### BRIEF DESCRIPTION OF THE DRAWINGS

The above needs are at least partially met through provision of the enterprise-accessible customer locker described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings

FIG. 18 comprises a block diagram as configured in accordance with various embodiments of these teachings;

FIG. 19 comprises a flow diagram as configured in accordance with various embodiments of these teachings;

FIG. 20 comprises a flow diagram as configured in accordance with various embodiments of these teachings;

FIG. 21 comprises a block diagram as configured in accordance with various embodiments of these teachings;

FIG. 22 comprises a block diagram as configured in accordance with various embodiments of these teachings;

FIG. 23 comprises a block diagram as configured in accordance with various embodiments of these teachings;

FIG. 24 comprises a flow diagram as configured in accordance with various embodiments of these teachings;

FIG. 25 comprises a block diagram as configured in accordance with various embodiments of these teachings;

FIG. 26 comprises a block diagram as configured in accordance with various embodiments of these teachings;

FIG. 27 comprises a block diagram as configured in accordance with various embodiments of these teachings;

FIG. 28 comprises a flow diagram as configured in accordance with various embodiments of these teachings;

FIG. 29 comprises a block diagram as configured in accordance with various embodiments of these teachings;

FIG. 30 comprises a flow diagram as configured in accordance with various embodiments of these teachings; and

FIG. 31 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. As used herein, the expression “configure” and its variations (such as “configured”) will be understood to refer to a purposeful and specifically designed and intended physical state of configurability and is not intended to include the more general notion of something being forcibly capable of assuming some alternative or secondary purpose or function through a subsequent repurposing of a given enabling platform.

### DETAILED DESCRIPTION

Vending machines are known in the art. As used herein, references to a “vending machine” (or “vending apparatus” or “vending platform”) will be understood to refer to an apparatus that serves, in the absence of a human custodian, attendant, or operator to provide a customer with some product or service in exchange for some consideration. Millions of vending machines, for example, serve to exchange a customer's proffered coins, currency, or credit for food items or drinks. Many other items are similarly offered via this approach.

Typical vending apparatuses are necessarily size limited and hence can only stock a relatively small inventory of vendible products. A priori knowledge of categorical demographic data for typical persons expected to be in the vicinity of a particular vending apparatus, such as age-based information, occupational information, and so forth, can be helpful to inform the inventory selection process. Such approaches, however, are necessarily limited. As a result, to some very large extent, successful inventory selections are often the result of trial and error over time for any given vending machine in any given location,

Generally speaking, many of these embodiments provide a vending apparatus that comprises a housing that contains products that are available to be vended, a wireless data interface, and a control circuit disposed within the housing and that operably couples to the wireless data interface. By one approach the control circuit is configured to wirelessly communicate via that wireless data interface with local user devices (such as so-called smart phones and smart watches) to thereby receive one or more personalizing identifiers that correspond, for example, to the corresponding user of the device. The control circuit can then automatically employ that personalizing identifier to facilitate future product stocking selections for the vending apparatus. Some embodiments provision vending apparatuses with wireless communications capabilities.

By one approach the control circuit within the vending apparatus housing itself makes specific stocking selections. By another approach the control circuit facilitates such selections by forwarding the personalizing identifier (with or without other information) to another control circuit (such as a remote server) where the actual stocking selections are made.

By one approach the foregoing selection process includes correlating the personalizing identifier to a particular person and then accessing previously-stored partiality information for that particular person. That partiality information can then be used to select products from amongst a plurality of candidate products to stock in the vending apparatus. By one approach that partiality information is represented by corresponding partiality vectors having at least one of a length and an angle that corresponds to a magnitude of the particular person's belief in an amount of good that comes from an order associated with the corresponding partiality.

These teachings are highly flexible in practice and will accommodate various modifications and/or supplemental capabilities. For example, by one approach these teachings will accommodate maintaining a count of a number of episodes during which the personalizing identifier for a particular device/user is received from a particular device and then conditioning the automatic employment of the personalizing identifier as described above as a function, at least in part, of that count. So configured, stocking selections can be weighted more heavily in favor of a higher count such that inventory selections can be skewed in favor of persons who are more often in the vicinity of the vending apparatus as compared to people who are less frequently so located.

Prior to describing a vending apparatus that is representative of these teachings, it may be helpful to first explain a relevant view of a person's partialities and how such partialities can be represented and utilized to help identify products that are likely to appeal to a given individual.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

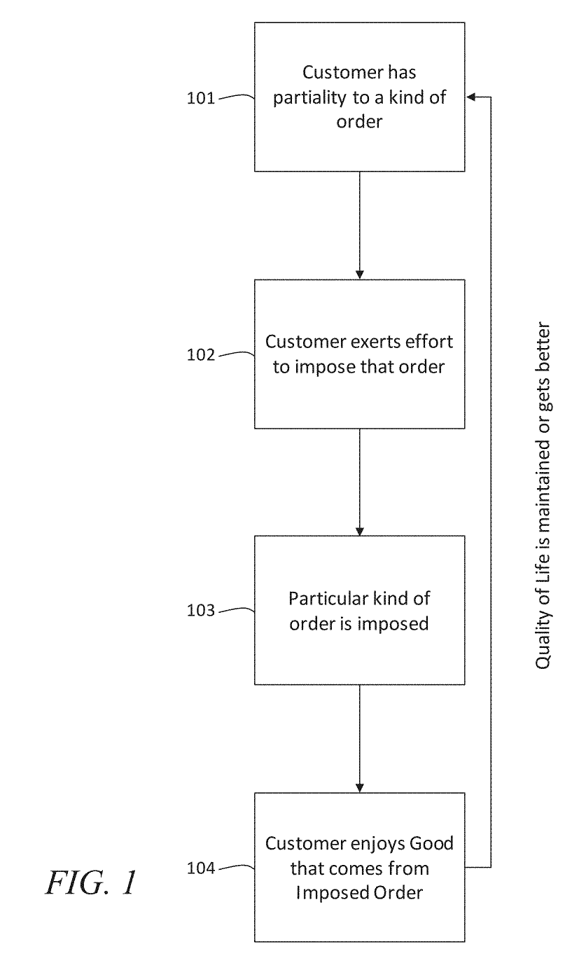

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

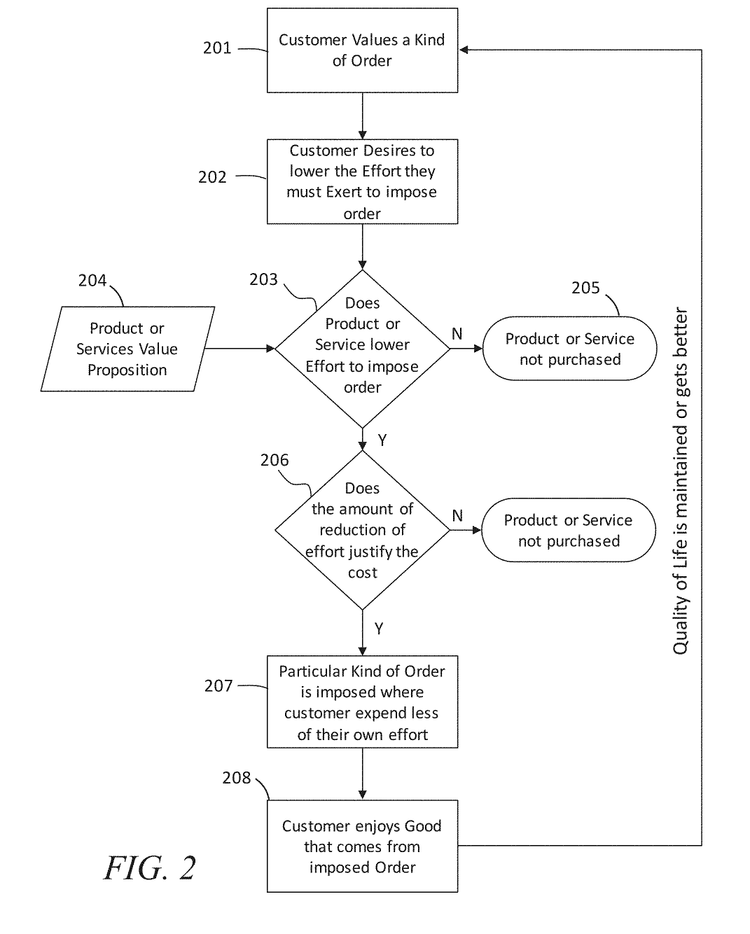

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

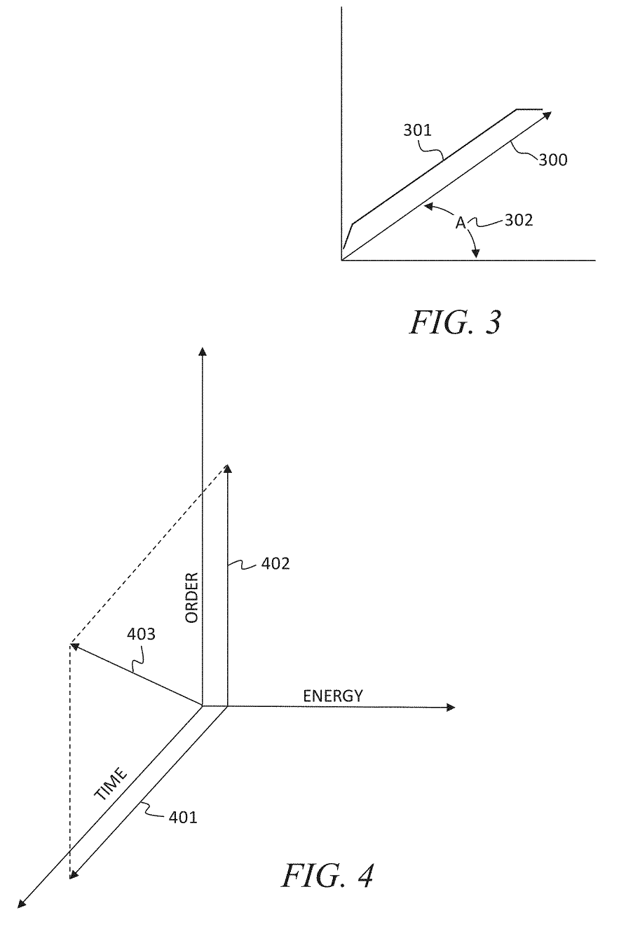

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

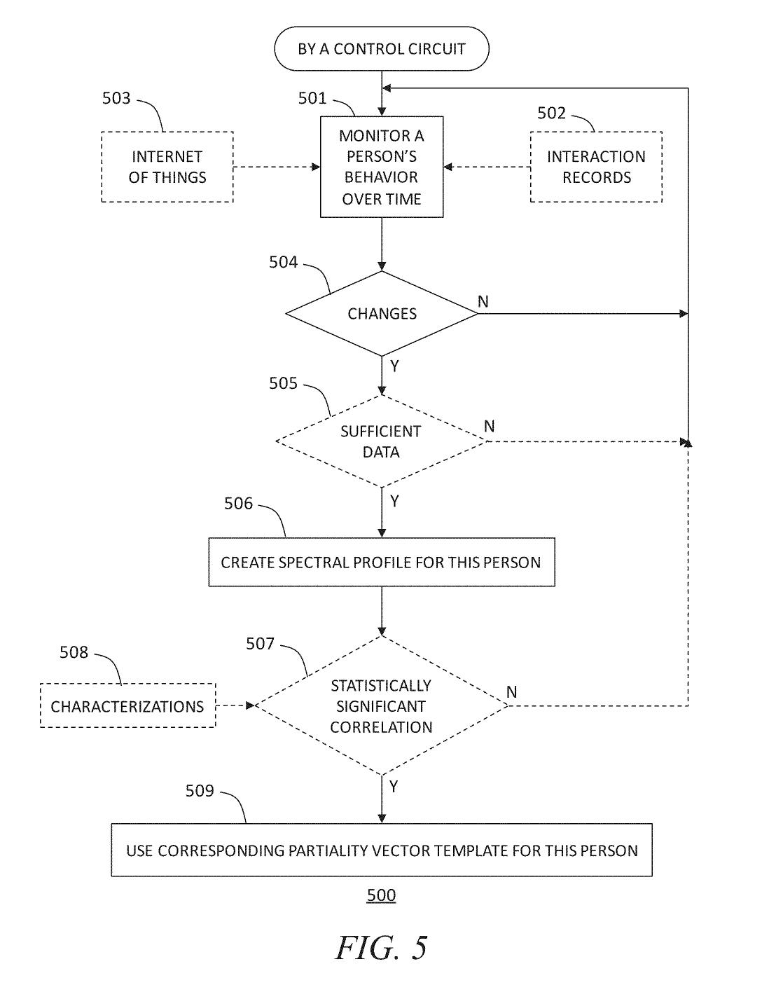

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020, (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

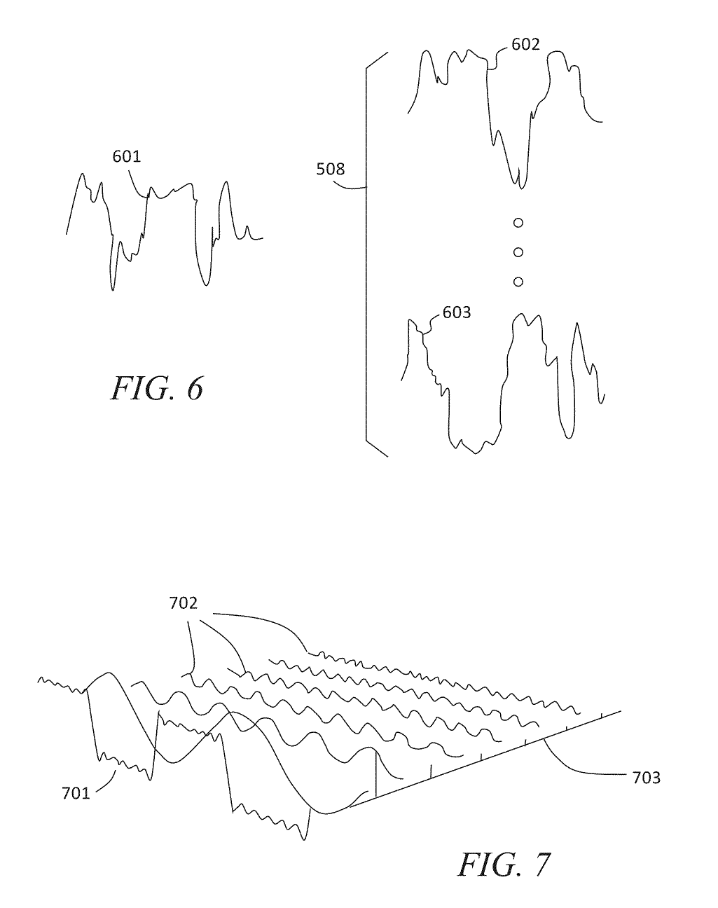

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself. (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

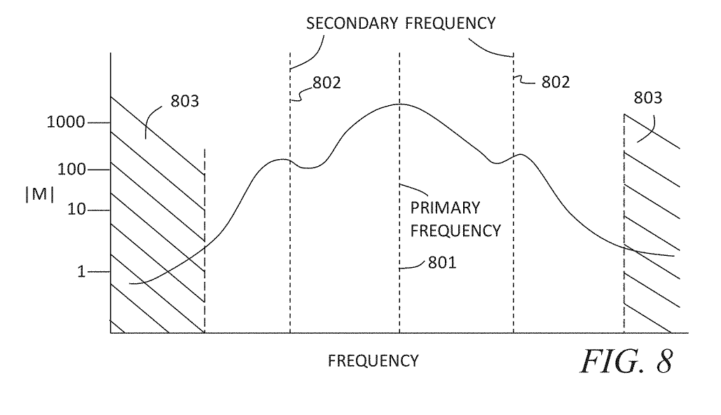

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week; then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

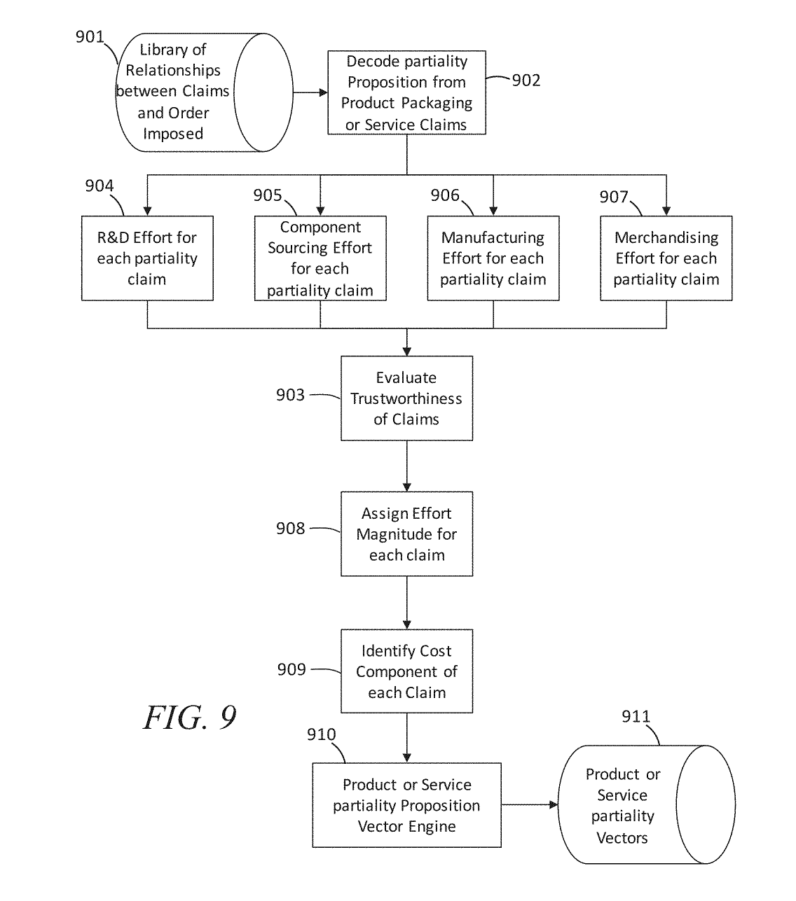

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

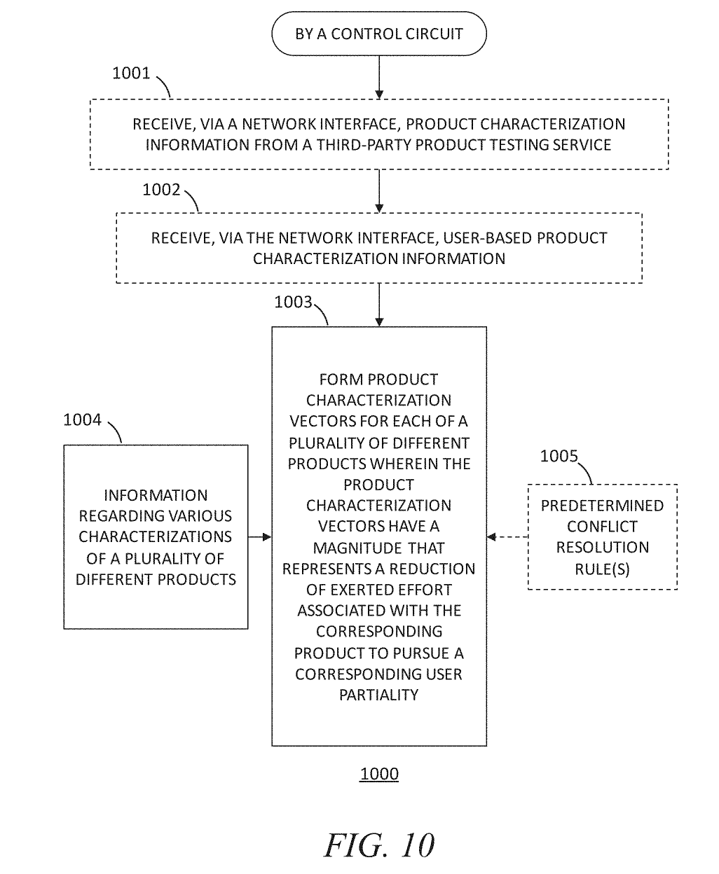

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

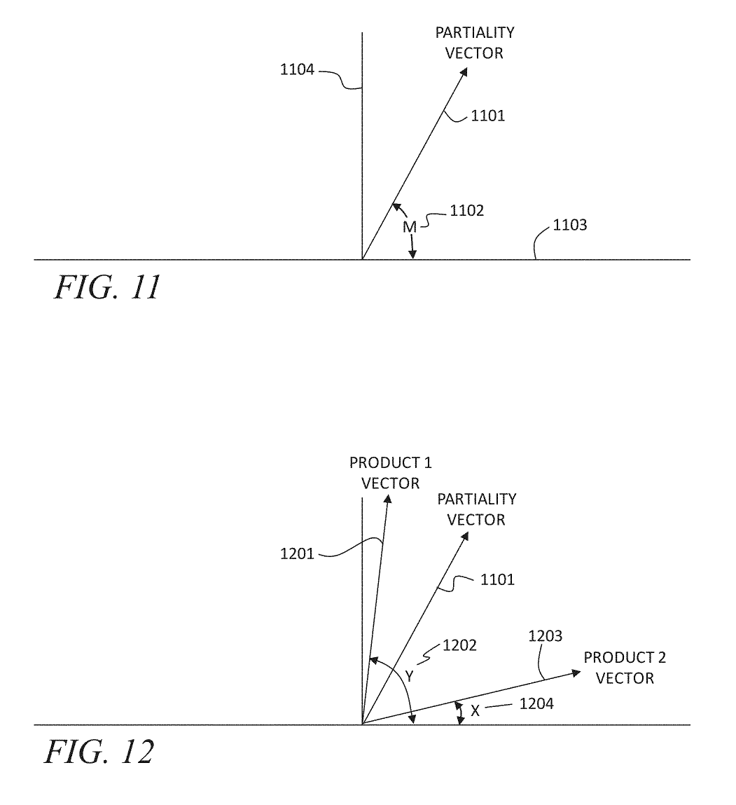

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·Ply) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥1/2∥. Accordingly, although the organic apples cost more than the non-organic apples, the dot product result for the organic apples exceeds the dot product result for the non-organic apples and therefore identities the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥1/2∥), but the dot product for the $10/week organic apples may now drop (for example, to ∥1/2∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

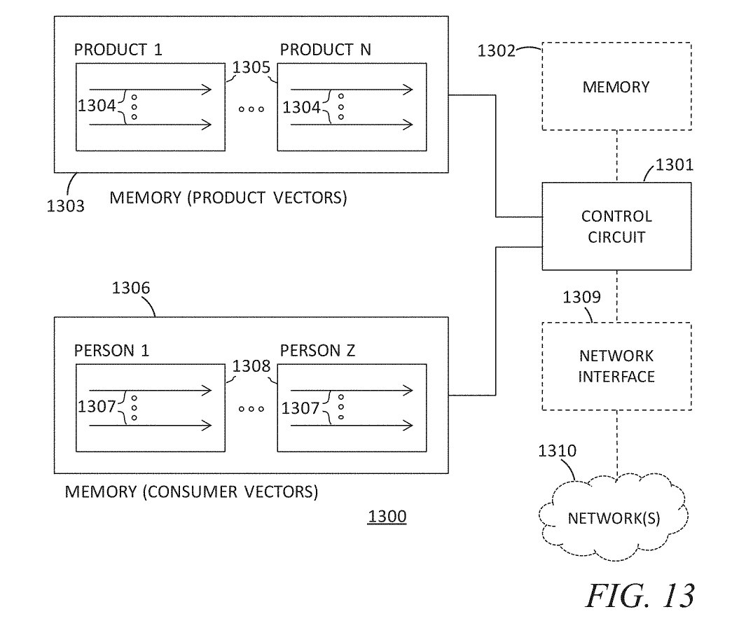

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

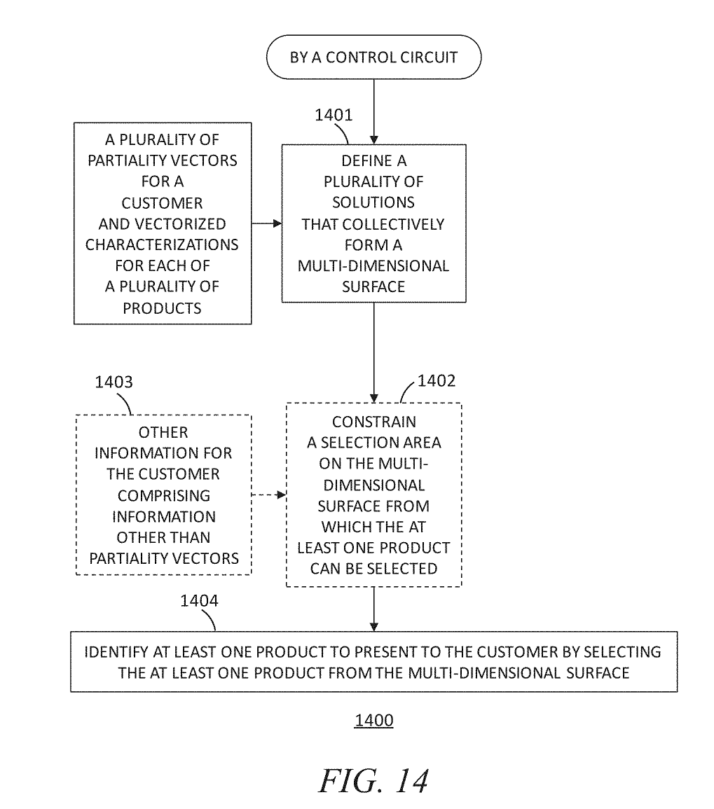

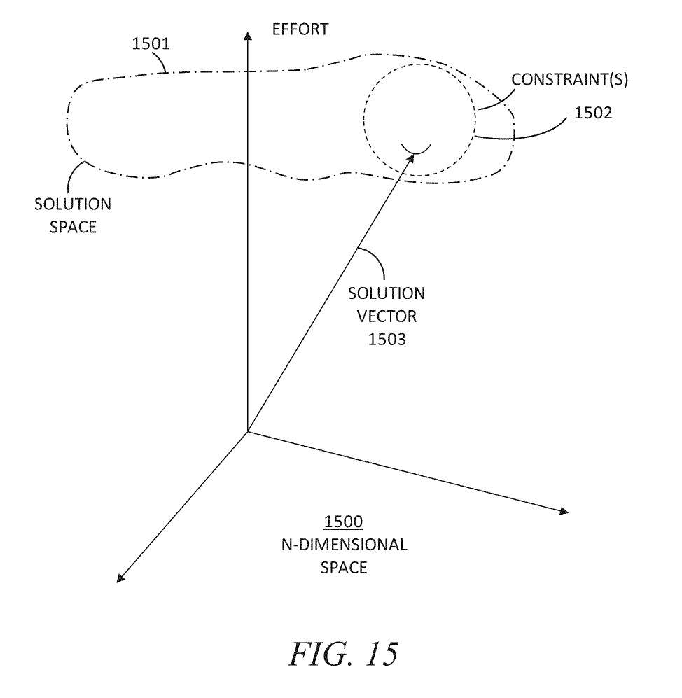

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

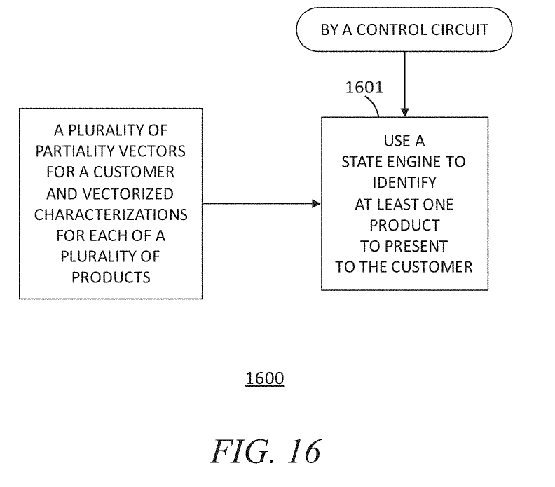

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

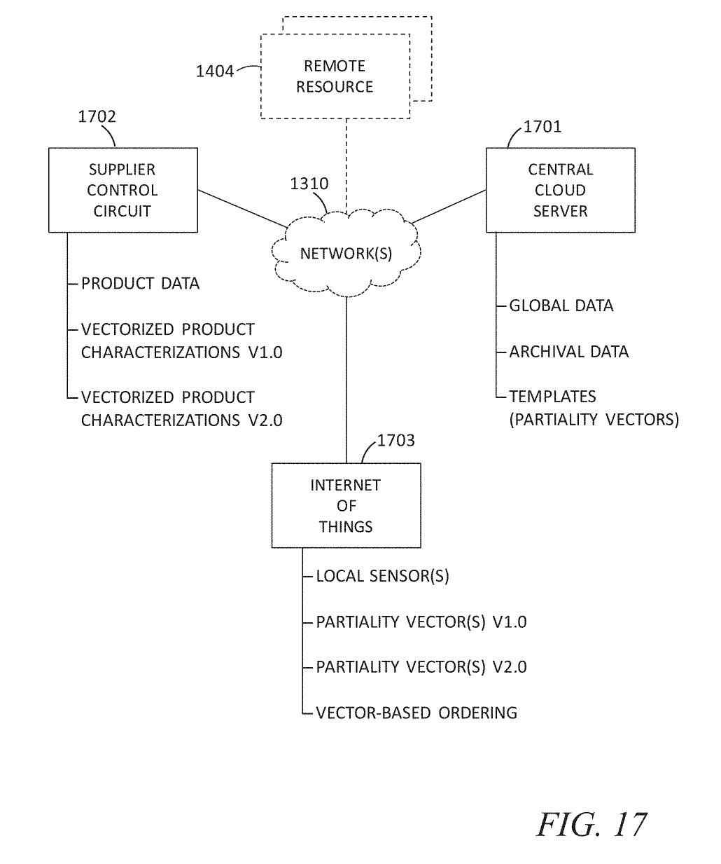

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of circuit 1702 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

In accordance with the foregoing rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

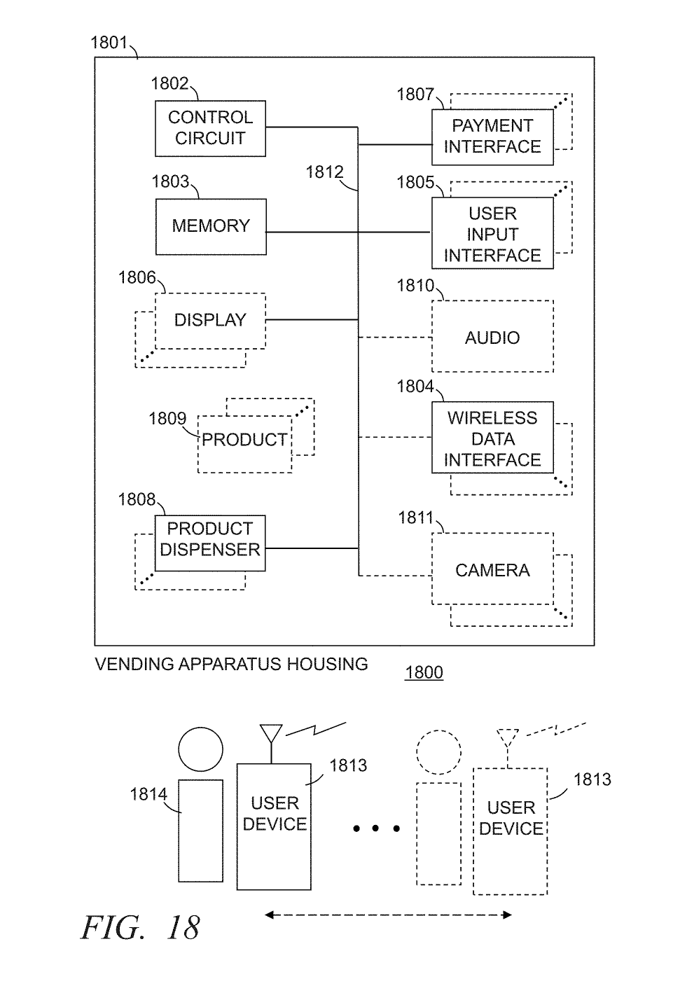

As noted above, the present teachings pertain to the stocking of a vending apparatus based, at least in part, upon partiality information (whether represented in a vector format or not) as described above. FIG. 18 presents an illustrative example of a vending apparatus 1800 configured in accordance with these teachings. This vending apparatus 1800 comprises a housing 1801. Various vending apparatus housings are known in the art and the present teachings are not overly sensitive to any particular selection in these regards.

In this illustrative example the vending apparatus 1800 includes a control circuit 1802 that is contained within the vending apparatus housing 1801. (By one approach this control circuit 1802 is the same as the control circuit 1301 described above with reference to FIG. 13. By another approach, the control circuit 1802 is physically and logically distinct from the above-described control circuit 1301. And by yet another approach this vending apparatus control circuit 1802 comprises a part, but not the whole, of the above-described control circuit 1301.)

Being a “circuit,” the control circuit 1802 comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1802 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1802 is configured (for example, by using corresponding programming as will be well understood by those skilled in the art) to carry out one or more of the steps, actions, and/or functions described herein.

In this illustrative example the control circuit 1802 operably couples to a memory 1803 that is also contained within the vending apparatus housing 1801. This memory 1803 may be integral to the control circuit 1802 or can be physically discrete (in whole or in part) from the control circuit 1802 as desired. This memory 1803 can also be local with respect to the control circuit 1802 (where, for example, both share a common circuit board, chassis, power supply, and/or housing) or can be partially or wholly remote with respect to the control circuit 1802.

In addition to the aforementioned partiality information, this memory 1803 can serve, for example, to non-transitorily store the computer instructions that, when executed by the control circuit 1802, cause the control circuit 1802 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM))).)

In this illustrative example the control circuit 1802 also operably couples to at least one wireless data interface 1804. Various wireless data protocols are known in the art and may be suitably employed here. Examples include but are not limited to Bluetooth and Wi-Fi-compatible protocols. (Bluetooth™ (herein referred to as “Bluetooth”) refers to a wireless communications standard managed by the Bluetooth Special Interest Group. The Bluetooth standard makes use of frequency-hopping spread spectrum techniques and typically provides for only a very short range wireless connection (typically offering a range of only about ten meters in many common application settings). This standard comprises a packet-based approach that relies upon a so-called master-slave paradigm where a master device can support only a limited (plural) number of subservient devices. Wi-Fi refers to a technology that allows electronic devices to connect to a wireless Local Area Network (LAN) (generally using the 2.4 gigahertz and 5 gigahertz radio bands. More particularly, “Wi-Fi” refers to any Wireless Local Area Network (MAN) product based on interoperability consistent with the Institute of Electrical and Electronics Engineers' (IEEE) 802.11 standards.)

The foregoing examples of wireless data protocols are meant to serve an illustrative purpose and are not meant to suggest any particular limitations in these regards, either with respect to presently known and available protocols or with respect to future-developed wireless data protocols.

In this example the vending apparatus 1800 includes one or more user-input interfaces 1805 that also operably couple to the control circuit 1802. This interface 1805 serves to permit a customer to, for example, select a particular vendable item to be purchased. By one approach, this user-input interface 1805 can comprise a related or integral part of a touchscreen display 1806 that also comprises a part of the vending apparatus 1800. So configured, the customer can provide input to the control circuit 1802 by touching particular portions of the screen comprising the display 1806. One or more of these user-input interfaces 1805 may also accommodate other interface paradigms. Examples in these regards include, but are not limited to, cursor control interfaces (such as a mouse, arrow keys, trackball, joystick, or the like), alphanumeric-entry keypads, dedicated (or soft) buttons, switches, or the like, voice-recognition interfaces, gesture-recognition interfaces, gaze-tracking interfaces, and so forth. Such user-input interfaces are generally known in the art and, for the sake of brevity, will not be described further here.

In this example the vending apparatus 1800 also has one or more payment interfaces 1807. Such payment interfaces 1807 are known in the art and can serve to accept payment in the form of coins, currency, credit, debit, and gift card transactions, coupons or tokens, biometrics (as when a customer's fingerprint serves as their virtual credit or debit card), and wireless transactions (as when the customer presents a wireless smartcard, radio frequency identifier (RFID)-based card, module, or the like), to note but a few examples in these regards. The present teachings are not overly sensitive to any particular selection in these regards.

This vending apparatus 1800 also includes one or more product dispenser mechanisms 1808 configured to move a selected product 1809 from an inventory area within the vending apparatus housing 1800 to a dispensing area where the customer can physically retrieve their selected vended product as part of their vending transaction. Various such product dispenser mechanisms are known in the art and the present teachings are not particularly sensitive to any particular selection in these regards.

These teachings will accommodate other optional components as desired. By one approach, for example, the vending apparatus 1800 can also comprise an audio component 1810. This audio component 1810 can serve to store and selectively render audible any of a variety of useful sounds. These sounds can accompany and be synchronized with displayed video content or can comprise stand-alone audible content. The audible content itself can comprise any sounds that may be useful or necessary to meet the needs or opportunities as tend to characterize a given application setting. These sounds can include, but are not limited to, human speech, music, sound effects (for example, fanciful sounds or sounds that are appropriate and expected in the context of interacting with a vending machine), or tones or signals of various kinds that serve as alerts, indicators, acknowledgements, or the like.

Such a vending apparatus 1800 can also optionally comprise, if desired, one or more cameras 1811. This can comprise a still camera or a video camera as desired and may have a set field of view or a selectively-variable orientation or zoom capability as desired. Such a camera can be configured, for example, to view (and capture images of) some portion of or all of the customer (or customers) when standing before and/or are approaching the vending machine 1800. Such a camera or cameras can be specifically configured, if desired, to provide ordinary light or infrared light imaging and/or depth information.

These above-described components can communicate as appropriate amongst themselves and/or with the control circuit 1802 via any appropriate network interface. As illustrated, for example, a serial-data bus 1812 interconnects these components. This permits, for example, the control circuit 1802 to communicate with any of these components as necessary or appropriate. Those skilled in the art will recognize that other possibilities exist in these regards. For example, a star-based configuration could serve to directly link the control circuit 1802 to one or more of these components. As yet another example, a daisy chain-based configuration could serve to connect some or all of these components in a loop.

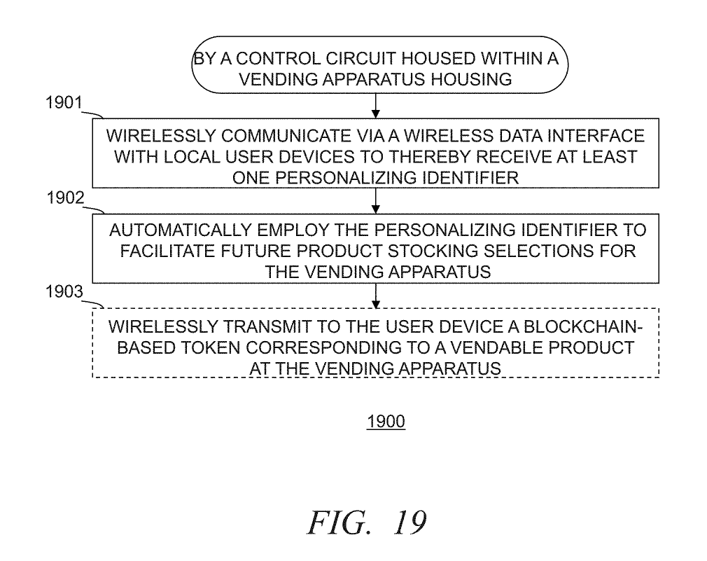

FIG. 19 presents a process 1900 that can be carried out by the vending apparatus control circuit 1802 in accordance with these teachings. Pursuant to this process 1900, at block 1901, the control circuit 1802 wirelessly communicates via the wireless data interface 1804 with local user devices 1813 (as shown in FIG. 18) as those devices 1813 move within the communication range of the wireless data interface 1804. These teachings will accommodate compatible communications with a variety of user devices. In a typical application setting these user devices 1813 comprise hand-held devices. As used herein, an apparatus is “hand-held” when the apparatus is sized and configured to be held during ordinary use using only a single normally-sized adult human hand. Useful examples include but are not limited to so-called smart phones, smart watches, laptop and pad/tablet-styled computers, and so forth.

By one approach, the aforementioned wireless communication may be a communication specifically configured to facilitate a communication specifically between the user device 1813 and the control circuit 1802 via the wireless data interface 1804. The foregoing may occur when, for example, the user device 1813 is a smart phone running an app that is preconfigured and suitably provisioned to support and carry out such a communication as a background process. By another approach this wireless communication may occur as a more generalized background process carried out by the user device 1813 to, for example, test and interrogate the local communications environment for access points, communications opportunities, pushed content, and so forth.

Any number of different items of information can be provided by the user device 1813 and/or otherwise exchanged via the wireless data interface 1804. Pursuant to this process 1900, however, at the very least this wireless communication includes at least one personalizing identifier that corresponds to the user device 1813 and/or a corresponding user 1814. In a typical application setting the personalizing identifier will uniquely identify the user device 1813 though not necessarily the corresponding user 1814.

By one approach the personalizing identifier comprises a Media Access Control (MAC) address. A MAC address is a unique identifier assigned to network interfaces for communications at the data link layer of a network segment. MAC addresses are used as a network address for many IEEE 802 network technologies, including Ethernet, Wi-Fi, and often Bluetooth. Logically, MAC addresses are used in the media access control protocol sublayer of the OSI reference model (“OSI” referring to “Open Systems Interconnection”). MAC addresses are most often assigned by the manufacturer of a Network Interface Controller (NIC) and are stored in its hardware, such as the card's read-only memory or some other firmware mechanism. If assigned by the manufacturer, a MAC address usually encodes the manufacturer's registered identification number and may be referred to as the burned-in address. It may also be known as an Ethernet hardware address, hardware address, or physical address. MAC addresses are formed according to the rules of one of three numbering name spaces managed by the Institute of Electrical and Electronics Engineers, (i.e., MAC-48, EUI-48, and EUI-64).

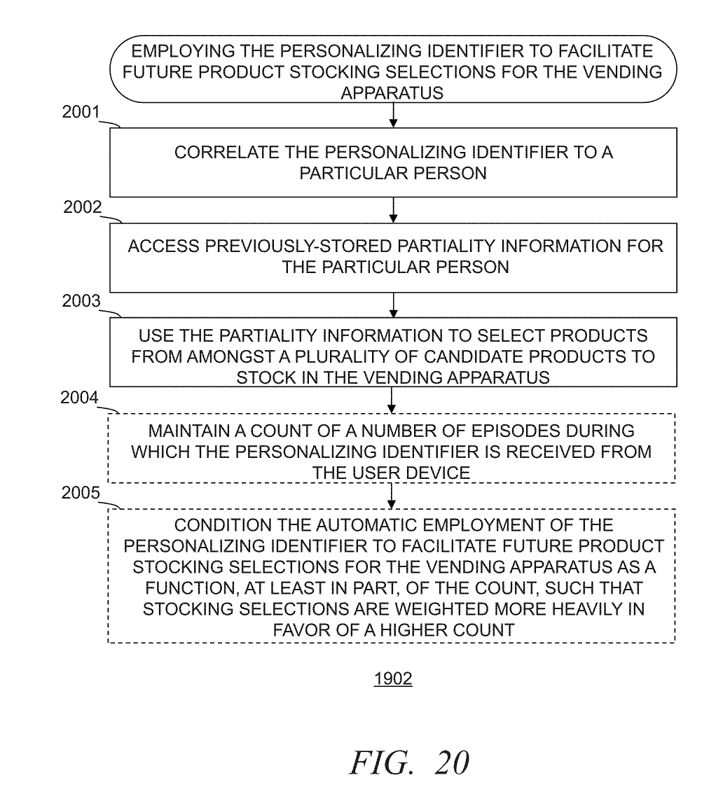

At block 1902 the control circuit 1802 automatically employs the aforementioned personalizing identifier to facilitate future product stocking selections for the vending apparatus 1800. These teachings will accommodate a variety of approaches in these regards. FIG. 20 presents a particular approach as an illustrative example. The specific details of this example are not intended to suggest any particular limitations.

At block 2001 the control circuit 1802 correlates the aforementioned personalized identifier to a particular person. By one approach, this comprises using the personalized identifier to access a database or lookup table that uniquely correlates such identifiers to corresponding persons. Such a resource can be developed using information provided by individual persons (for example, when they upload and initiate a corresponding smart phone app) and/or by using information available through other public and/or private sources. The present teachings are not overly sensitive to the specific selection of any particular approaches in these regards. By one approach, this correlation is undertaken only upon confirming that the corresponding person has previously given their permission for this use of their information.

At block 2002 the control circuit 1802 then accesses previously-stored partiality information for the identified particular person. As described above, this information can comprise, at least if desired, one or more partiality vectors for the particular person where each of the partiality vectors is at least one of a length and an angle that corresponds to a magnitude of this particular person's belief in an amount of good that comes from an order associated with each corresponding partiality. This partiality information may be locally available to the control circuit 1802 or may be obtained, partially or in whole, from other external, remote resources as desired.

At block 2003 the control circuit 1802 uses the aforementioned accessed partiality information to select products from amongst a plurality of candidate products to stock in the vending apparatus 1800. This activity can include using the vectorized characterizations for such candidate products as described above, where each of the vectorized characterizations indicates a measure regarding an extent to which a corresponding one of the candidate products accords with a corresponding one of the plurality of partiality vectors. In this case, product selection can be carried out as described above by identifying products that best align with the particular person's partialities.

This activity can include forming an initial pool of candidate products by circumscribing product types as a function, at least in part, of factors that pertain to the vending apparatus 1800 itself. For example, it may be inappropriate to stock a product in the vending apparatus 1800 having a price that exceeds some predetermined maximum price. As another example, size and/or weight limitations for products stored and dispensed by the vending apparatus 1800 can serve as yet another vetting criteria. As yet another example, expected shelf life and/or proper storage requirements can serve as yet another vetting criteria.

In addition, the pool of candidate products can be developed with an eye towards required and/or restricted product categories. Particular products may be legally prohibited from inclusion in a vending machine, for example. As another example, the contents of a particular vending machine may be restricted to snack foods per the requirements of the vending machine operator.

By one approach, and as illustrated at block 2004, this process 1902 can include maintaining a count of a number of episodes during which the personalizing identifier is received from the user device. (As used herein, “episodes” refers to separate instances of device proximity to the vending apparatus 1800, and hence contemplate the corresponding user, during a single episode, having approached and then departed from the vicinity of the vending apparatus 1800.) By one approach this count may be maintained for a predetermined window of time such as a particular number of consecutive days or weeks. Such a count can help to identify persons who tend to frequent an area proximal to the vending apparatus 1800 as versus persons who may only pass by that vending apparatus 1800 on rare occasions.

By one approach, and as illustrated at block 2005, this process 1902 can include conditioning the automatic employment of the personalizing identifier to facilitate future product stocking selections for the vending apparatus 1800 as a function, at least in part, of the aforementioned count. For example, particular candidate stocking selections identified by use of the partiality vectors for a particular person and the characterizing vectors for such products can be weighted more heavily in favor of stocking selections that correspond to one or more persons having a relatively higher count. So configured, a particular product that appears to well align with the partialities of a considerable number of people who all are frequently proximal to the vending apparatus 1800 will be more likely selected to be stocked in the vending apparatus 1800 then products that are poorly aligned with such a group of people and/or products that are well aligned with only a few people and/or a group of people who only occasionally visit the area proximal the vending apparatus 1800.

As an illustrative example and without intending to suggest any particular limitations in these regards, the above-described process might result in identifying that a significant number of persons who frequently pass by a particular vending apparatus all share an identifiable partiality for Snickers candy bars and energy drinks while a fewer number of passersby share an identifiable partiality for a different candy bar. Presuming that the vending apparatus lacks an ability to properly store and/or dispense energy drinks, and presuming further that there is a present interest in only stocking the vending apparatus with one new offering, the foregoing information can serve to help select Snickers candy bars as the new product to use in future stocking of this particular machine.

These teachings are highly flexible in practice and will accommodate various modifications and/or supplementations. As one example in these regards, and referring to block 1903 of FIG. 19, the control circuit 1802 can be configured to wirelessly transmit to a particular user device a Blockchain-based token corresponding to a vendable product at the vending apparatus 1800. This token may comprise, for example, an opportunity to receive the vendable product at the vending apparatus without cost or at some discount. By one approach, the control circuit 1802 uses the aforementioned partiality information for the particular person to select a particular vendable product to offer to the particular person via this Blockchain-based token. Using a Blockchain-based approach can help to avoid counterfeiting or other unauthorized attempts to exploit such opportunities.

An enterprise-accessible customer locker is physically located at a first customer's address. A control circuit can be configured to select products (including unordered products if desired) for a first customer to be placed in the aforementioned enterprise-accessible customer locker. The control circuit can also be configured to determine a need to deliver a particular product to a second customer who is physically discrete from the aforementioned first customer's address. The control circuit can then be further configured to arrange to transfer the particular product from the first customer's enterprise-accessible customer locker to the second customer at a delivery address corresponding to the second customer. By one approach, the foregoing can include a consideration of whether the particular product is in fact available at the first customer's enterprise-accessible customer locker and/or what the relevant timeframe is for when the first customer may in fact need the particular product.

As described above, traditionally, a retail storefront is the side of a physical retail store that faces a point of pedestrian access (such as a sidewalk, street, mall pathway, and so forth) and may (or may not) have one or more windows to offer potential customers a (possibly organized) view of one or more products that are available for retail sale at the store. As used herein it will be understood that a retail storefront is not a mere facade but in fact offers a customer physical access to products being offered for retail sale within the store.

Though a successful shopping paradigm for millennia, many consumers are preferring delivery services that avoid a need to physically visit a retail store. Unfortunately, using a delivery service in this context inherently necessitates some delay between initiating the retail transaction and taking delivery of the product being purchased. This delay may be days or even weeks in some cases. Some retailers are striving to reduce that delay to only a few hours, but even that amount of delay may be unacceptable to some consumers at least some of the time.

That said, holding down costs is also of paramount importance. Storage of unsold items represents one important cost point. In particular, warehouses, distribution centers, and storerooms all require a myriad of related expenses. Notwithstanding that such facilities as a modern distribution center are well designed and efficiently operated, those facilities nevertheless require costly space, utilities, personnel, and so forth.

To address such issues, concerns, and opportunities, these teachings will accommodate various embodiments that provide for an enterprise-accessible customer locker that is physically located at a first customer's address and a control circuit (that likely is physically located other than at the enterprise-accessible customer locker). The control circuit can be configured to select products (including unordered products if desired) for a first customer to be placed in the aforementioned enterprise-accessible customer locker. The control circuit can also be configured to determine a need to deliver a particular product to a second customer who is physically discrete from the aforementioned first customer's address. The control circuit can then be further configured to arrange to transfer the particular product from the first customer's enterprise-accessible customer locker to the second customer at a delivery address corresponding to the second customer.

By one approach, the foregoing can include a consideration of whether the particular product is in fact available at the first customer's enterprise-accessible customer locker and/or what the relevant timeframe is for when the first customer may in fact need the particular product.

These teachings are flexible in practice. As one example in these regards, the enterprise-accessible customer locker can comprise a secure-delivery receptacle or, if desired, an unattended retail storefront installed in the customer's residence.

By one approach, one or more product selections (for either or both of the first and second customer) can be based upon the use of partiality vectors for such customers along with vectorized product characterizations for each of a plurality of products as is described above in detail.

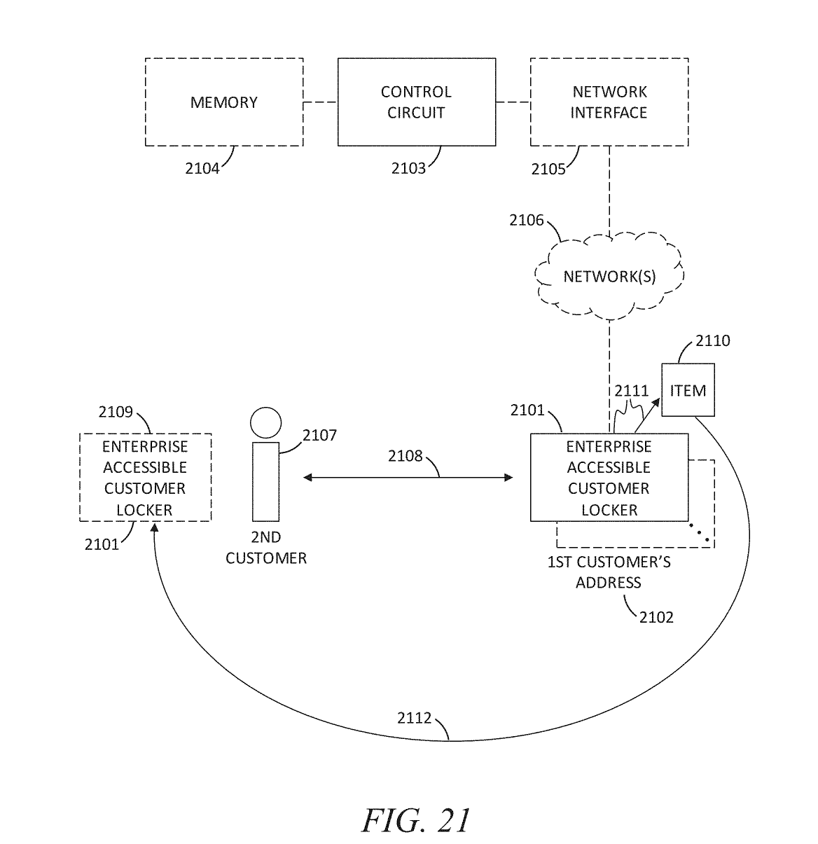

FIG. 21 presents an illustrative example of a relevant application setting in these regards where the enabling apparatus 2100 includes an enterprise-accessible customer locker 2101 that is physically located at a customer's address 2102 and a control circuit 2103.

The aforementioned customer's address 2102 can comprise any physical address of the customer's choosing. Examples include residential street addresses, apartment and unit numbers, business addresses, and so forth. The aforementioned enterprise-accessible customer locker 2101 may comprise a secure-delivery receptacle or an unattended retail storefront installed in the customer's residence at the aforementioned address.

As used herein, the expression “secure-delivery receptacle” shall be understood to refer to a delivered-package vault having a selectively-lockable access portal. This delivered-package vault is typically located outside the customer's residence (though such a vault may be physically disposed within a sheltered common area of a multi-family building such as an apartment or condominium structure). Accordingly, both the delivery person and the customer typically gain access to the interior of the vault via the aforementioned access portal, which access portal is itself disposed outside the customer's residence.

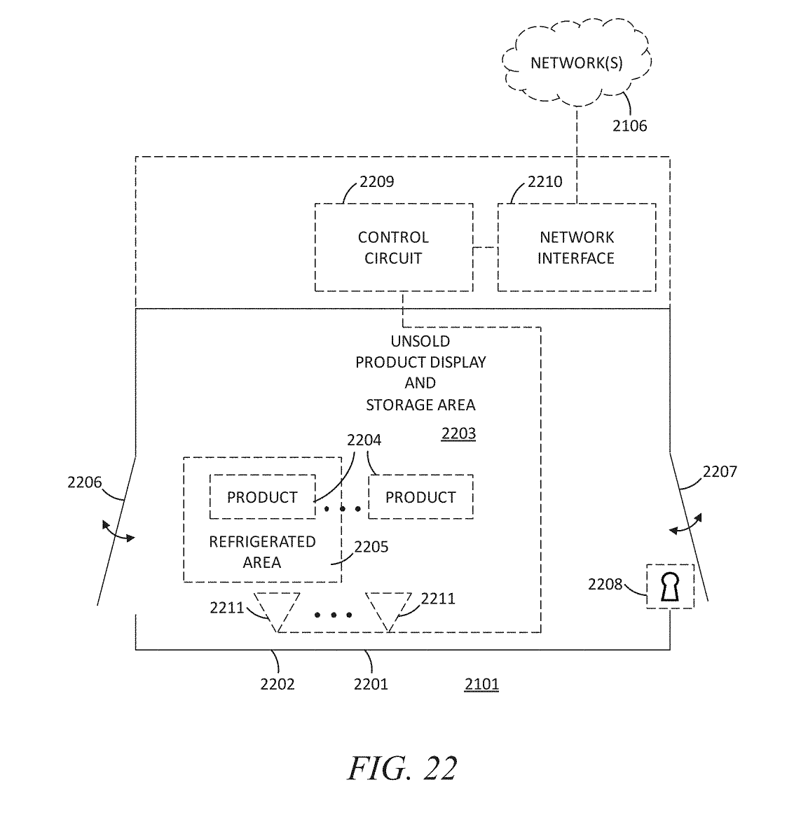

While these teachings can be readily and usefully deployed in conjunction with a secure-delivery receptacle, for many application settings it will be beneficial for the enterprise-accessible customer locker 2101 to constitute an unattended retail storefront that is installed in the customer's residence. FIG. 22 presents an example of an unattended retail locker 2101. As used herein, the expression “unattended” means that a customer can peruse the products that are available for retail sale and the customer can purchase and remove a particular product without any human assistance or attendance on the part of the retailer. Also, in additional to a traditional retail storefront, the expression “retail storefront” as used herein shall further be understood to include other parts of the store that lie behind the traditional storefront.

The unattended retail storefront 2201 in this example includes a housing 2202. This housing 2202 can have essentially any form factor that may be convenient or otherwise appropriate to the application setting. In this illustrative example the housing 2202 comprises a hexahedron and, in particular, a rectangular cuboid. The housing 2202 and be comprised of any desired material, keeping in mind that securing its contents will typically dictate using relatively strong materials and sturdy manufacturing techniques.

The housing 2202 at least includes an unsold product display and storage area 2203 that can be stocked with a variety of unsold products 2204. These products 2204 can all be the same or can comprise a mix of different products as desired. By one approach at least one area of the unsold product display in storage area 2203 comprises a refrigerated area 2205. This refrigerated area 2205 and serve to maintain perishable items at a refrigerated temperature (such as near but above 32° F.) or at a frozen temperature (such as below 32° F.) as appropriate to the application setting.

In this illustrative example the housing 2202 also includes a retail-access portal 2206 that provides selective access from a consumer's residence to the unsold product display in storage area 2203 (as illustrated below in more detail). So configured this retail-access portal 2206 is configured to provide a consumer in the consumer's residence with shopping access to the unsold product display in storage area 2203. By one approach this retail-access portal 2206 comprises at least one door that pivots, slides, or otherwise move in order to provide access to the unsold product display in storage area one or two via a corresponding opening through the housing 2202. Multiple such doors can be provided as desired for ease of access or, for example, to provide access to refrigerated and non-refrigerated area, respectively.

By one approach the retail-access portal comprises a non-lockable portal. In this case, though the door can be closed to thereby obstruct access to the unsold product display and storage area 2203, and may be retained in a closed position by, for example, a latching mechanism, the consumer is not prevented from opening the door via some opening for unlatching approach. If desired, a locking mechanism can be provided that is usable by the consumer to control entry from within the residence to the unsold product display and storage area 2203.

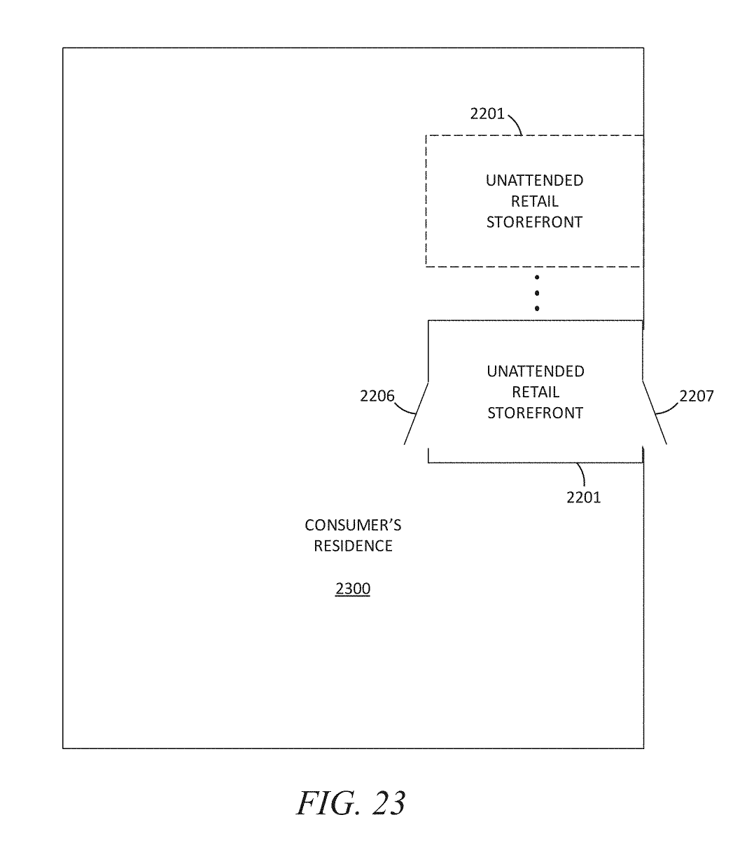

In this illustrative example, the housing 2202 also includes an inventory-loading portal 2207. This inventory-loading portal 2207 is physically distinct and separate from the aforementioned retail-access portal 2206. With momentary reference to FIG. 23, this inventory-loading portal 2207 therefore provides selective access from outside the consumer's residence 2300 to the unsold product display and storage area 2203 and therefore provides a retail enterprise (directly or through a surrogate such as an authorized delivery service) with inventory-maintenance access to the unsold product display and storage area 2203.

The inventory-loading portal 2207 can again comprise a pivoting or sliding door of choice that serves to selectively obstruct access to the unsold product display in storage area 2203 from outside the consumer's residence. Generally speaking, it will typically be beneficial for the inventory-loading portal 2207 to comprise a lockable portal. In this example the inventory-loading portal 2207 includes a locking mechanism 2208 that can selectively lock the inventory-loading portal 2207 in a closed position. This locking mechanism 2208 is configured to be unlocked by an authorized representative of the retail enterprise to which the unattended retail storefront 2201 corresponds. Various locking mechanisms are known in the art including key operated locking mechanisms as well as locking mechanisms that respond to entry codes that are manually entered, locking mechanisms that respond to a wirelessly transmitted code, and so forth. As the present teachings are not particularly sensitive to any particular choices in these regards, further elaboration here in these regards is avoided for the sake of brevity.

In this particular example, the unattended retail storefront 2201 includes its own control circuit 2209. This control circuit 2209 can be architected the same or similar to the aforementioned control circuit 2103 and can also operably couple to a corresponding network interface 2210. So configured this control circuit 2209 can communicate with other elements (both within the unattended retail storefront 2201 and external thereto) through the one or more aforementioned networks 2016 via this network interface 2201. As one particularly salient example this network interface 2210 can serve to couple this control circuit 2209 to the aforementioned control circuit 2103.

By one optional approach the unattended retail storefront 2201 includes one or more sensors 2211 that are configured to detect product presence. Examples in these regards include but are not limited to weight sensors, ultrasonic transponders, camera-based components, radio frequency identification (RFID) tag readers, and so forth. Such sensors 2211 can be located, for example, at least partially within the unsold product display in storage area 2203 or otherwise as desired.

So configured, and presuming that these sensors 2211 are directly or indirectly coupled to the control circuit 2209, the control circuit 2209 can detect the presence of particular products and also when a consumer removes a particular product 2204 from the unsold product display and storage area 2203. Similarly, the control circuit 2209 can detect when a consumer properly returns a particular product 2204 back to the unsold product display and storage area 2203 (for example, after having removed the product from the unsold product display and storage area 2203 to physically examine the product and having returned the product to the unsold product display and storage area 2203 within a predetermined time (such as, for example, 30 seconds, one minute, five minutes, or other duration of choice) upon having decided to not purchase the product at this time.

Referring again momentarily to FIG. 23, these teachings will accommodate installing a plurality of unattended retail storefronts 2201 at a single consumer's residence 2300. Such a plurality of unattended retail storefronts 2201 can be physically positioned adjacent or nearly adjacent one another, or can be located further apart. For example, it may be useful to provide one unattended retail storefront 2201 in one room of the consumer's residence 2300 and another unattended retail storefront 2201 in another, different room of the consumer's residence 2300. When providing multiple unattended retail storefronts 2201, these teachings will readily accommodate stocking the different unattended retail storefronts 2201 with partially or wholly differing products as desired.

The unattended retail storefront 2201 can be physically stocked by an appropriate associate or agent of the enterprise that owns and/or operates the unattended retail storefront 2201. These teachings will also accommodate, if desired, including an unmanned motorized transport unit configured to carry unsold products 2204 to the unattended retail storefront 2201 and convey the unsold products 2204 to the unsold product display and storage area 2203 via the inventory-loading portal 2207. If desired, this unmanned motorized transport unit can be further configured to remove unsold (or returned) products from the unsold product display and storage area 2203 via the inventory-loading portal 2207. Such an unmanned motorized transport unit can comprise, for example, a terrestrial or airborne drone configured to properly interact with the unattended retail storefront 2203 in these regards.

So configured, a consumer can have ready access to a variety of products without leaving their home and with effectively no delay between purchasing and taking possession of a particular product. Assuming appropriate stocking of the enterprise-accessible customer locker 2101, these teachings can greatly improve the consumer experience to a point where “shopping” is very nearly a completely transparent process that requires almost no shopping for delivery time in and of itself.

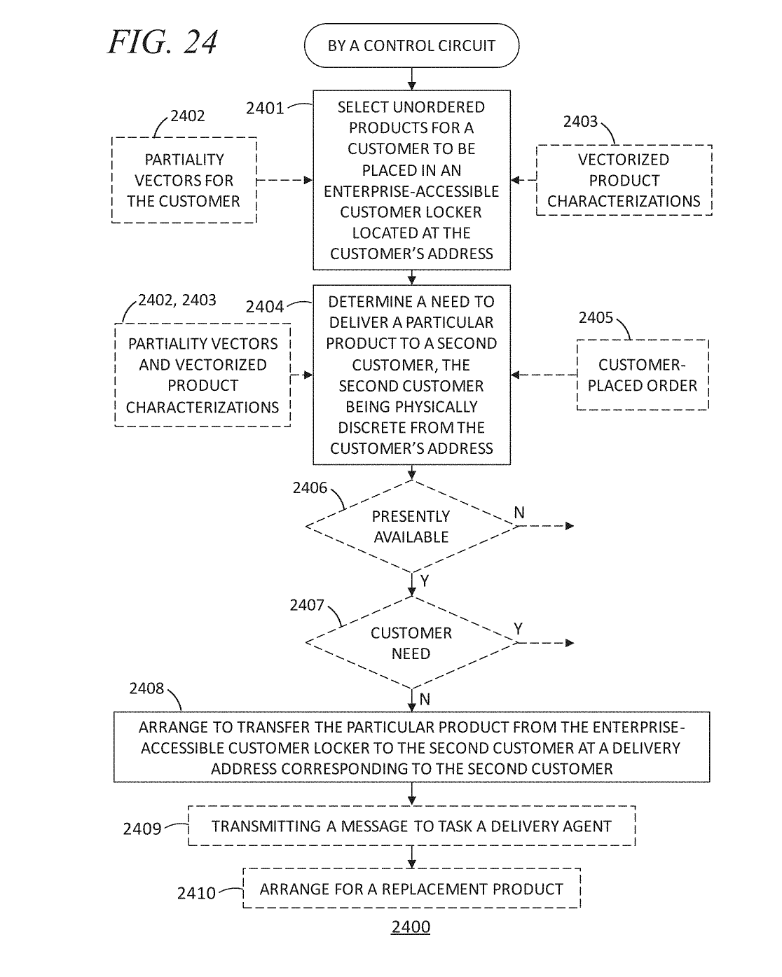

That said, the present teachings will also accommodate selectively removing unsold items from a particular enterprise-accessible customer locker 2101 in order to better serve a different customer (and in a way that does not unduly inconvenience or frustrate the first customer). FIG. 24 presents an illustrative example in these regards. For the sake of this illustrative example it will be presumed that the aforementioned enterprise control circuit 2103 carries out at least some or all of the described steps, actions, and functions of this process 2400.

At block 2401 the control circuit 2103 selects products for the aforementioned first customer to be placed in that customer's enterprise-accessible customer locker 2101 (such as the above-described secure-delivery receptacle or unattended retail storefront 2201) at the first customer's address 2102. There are various ways by which such products can be selected. By one simple approach the products are specifically ordered by the first customer. By another approach the first customer selected ongoing automatic periodic deliveries of such products. By yet another approach the control circuit 2103 selects an unordered product (i.e., a product that the customer has not ordered for near-term delivery or automated periodic delivery). Selection of an unordered product can be made as a function, at least in part, of information 2402 including a plurality of partiality vectors for the customer and vectorized product characterizations 2403 for each of a plurality of products. (Further details regarding partiality vectors and vectorized product characterizations are provided further below.)

The selected products are then delivered in a manner appropriate to the application setting to the enterprise-accessible customer locker 2101 at the first customer's address 2102.

At block 2404 the control circuit 2103 next determines a need to deliver a particular product to a second customer 2017. This second customer 2017 is physically discrete from the first customer's address 2102. Accordingly, at a minimum, the second customer 2017 is located at some meaningful distance 2108 from the legal ambit of the first customer's address 2102. These teachings will accommodate a very short distance 2108 (for example, when the second customer 2017 is a next-door neighbor to the first customer) or larger distances (such as hundreds or thousands of feet of physical separation) as desired.

By one approach the control circuit 2103 determines this need as a function, at least in part, based upon a customer-placed order 2405 that was placed by or on behalf of the second customer 2017. Such an order may have been placed in person, over the telephone, or via an on-line or app-based interface as desired. As another example, this need may be determined, at least in part, as a function of partiality vectors for the second customer 2017 and vectorized product characterizations for various products. In this case, the second customer 2017 need not have placed a specific order for the particular product and, in fact, may never have ordered or purchased any products whatsoever from the enterprise. (And again, details regarding partiality vectors and vectorized product characterizations are provided further below.)

Pursuant to this process 2400, the control circuit 2103 then assesses the contents of the first customer's enterprise-accessible customer locker 2101 to determine whether the particular product selected for the second customer 2017 is presently available at the first customer's enterprise-accessible customer locker 2101. In those regards, at optional block 2406, the control circuit 2103 can determine whether the particular product is, in fact, presently available at the first customer's enterprise-accessible customer locker 2101. This determination can be based, for example, on inventory information that the control circuit 2103 may be able to access. By another approach the control circuit 2103 queries the enterprise-accessible customer locker 2101 at the time of need to receive information regarding the present unsold contents thereof.

In the absence of detecting such availability this process 2400 can accommodate any of a variety of corresponding responses. Examples of possibly useful responses can include assessing the contents of enterprise-accessible customer lockers for other customers and/or terminating this process 2400 in favor of another order-fulfillment process of choice.

Upon determining that the particular product is presently available at the first customer's enterprise-accessible customer locker 2101, at optional block 2407 the control circuit 2103 can next determine whether the first customer will not likely need that particular product for at least a predetermined period of time. By one approach, that predetermined period of time can be equal to the time it will take to replenish this particular item at the first customer's enterprise-accessible customer locker. By one approach this predetermined period of time can be static and apply in all such cases or can be dynamic and determined, for example, on a case-by-case basis depending upon various factors such as availability of replenishment product in other locally-available inventory, delivery resources, traffic and weather conditions, and so forth.

By one approach the aforementioned assessment regarding the first customer's need for the particular product can be based upon an order/usage history for that first customer. By another approach, in lieu of the foregoing or in combination therewith, the aforementioned assessment can be based, in whole or in part, upon one or more partiality vectors for the first customer (where such partiality vectors can shed useful light upon when the first customer may need the particular product).

In the absence of detecting a useful window of time in these regards this process 2400 can again accommodate any of a variety of responses including checking the contents of other enterprise-accessible customer lockers for other customers or terminating this process 2400 in favor of a different order-fulfillment process.

Upon determining that the particular product is both available at the first customer's enterprise-accessible customer locker and that the first customer will not likely need that particular product within the relevant timeframe, at block 2408 the control circuit 2103 arranges to transfer the particular product from the enterprise-accessible customer locker for the first customer to the second customer 2017 at a delivery address corresponding to the second customer 2017. By one approach, the foregoing can include automatically tasking a delivery agent with transferring the particular product. In these regards, and referring to optional block 2409, the foregoing tasking can include automatically sending a message to so task the delivery agent. By one approach the message can include information (such as an unlock code) to unlock the first customer's enterprise-accessible customer locker 2101 to thereby permit the delivery agent to open the enterprise-accessible customer locker 2101 and thereby gain access to the particular product stored therein.

As one simple example in these regards, when the second customer 2017 also has an enterprise-accessible customer locker 2109 the particular product 2110 can be removed from the first customer's enterprise-accessible customer locker 2101 (as denoted by reference numeral 2111) and moved to and placed in the second customer's enterprise-accessible customer locker 2109 (as denoted by reference numeral 2112). Other delivery paradigms can be readily accommodated by this process 2400 as well.

If desired, and as illustrated at optional block 2410, the control circuit 2103 can also arrange for a replacement product for the particular product to be placed in the first customer's enterprise-accessible customer locker 2101 prior to when that customer will likely need the removed particular product.

So configured, the distributed inventory for a given enterprise can be further leveraged to serve additional customers and potential customers without inconvenience to any of the customers. In particular, these teachings make it possible to provide products more quickly to those in need and in potential need of those products in a way that can reduce various overhead expenses and resource requirements for the enterprise. As a result, the customers can receive improved service at a lesser cost.

As noted above, various aspects of these teachings can be further leveraged and/or realized by use of partiality vectors for one or more of the customers along with vectorized product characterizations. Detailed description regarding the nature, formation, and use of such features appears elsewhere in this description.

Planning for an event can be time consuming. In addition to preparing a guest list and planning for occasion specific details, a planner might have to go out to the store to buy supplies, food, decorations, and other products. The planner then has to transport the materials to the location of the event, which can be burdensome if the location is remote and requires that the materials be carried to the location.

With the foregoing in mind, these teachings are also able to accommodate preparing a locker of products for an event created by a user. The system advantageously utilizes a calendar application operating on a device of the user to obtain details of the event including a time, location, and attendees. The products included in the locker can be tailored to the event. The products can also be tailored to the user and, if desired, other attendees of the event. As such a user need not shop before an event or carry items to remote locations.

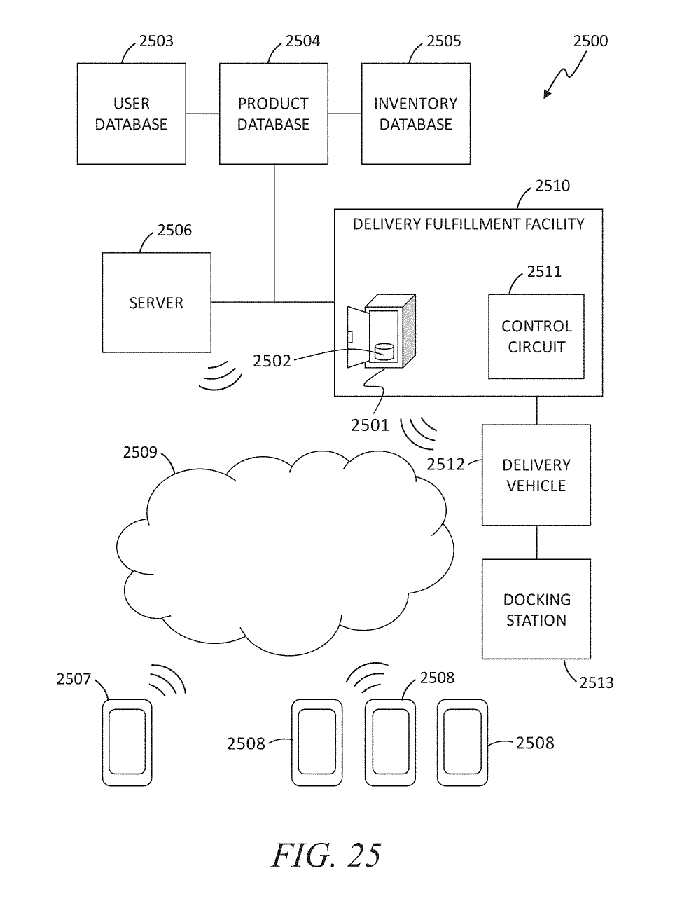

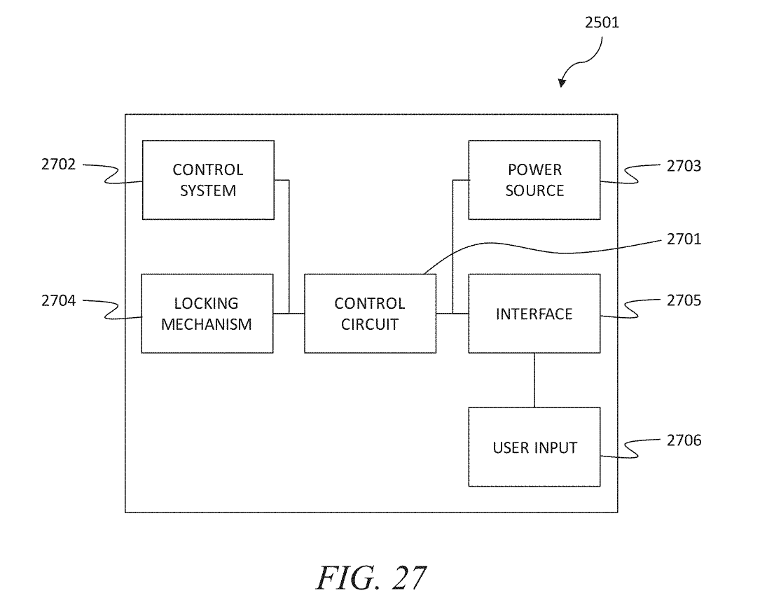

An event-based product locker preparation and delivery system 2500 is described herein with reference to FIGS. 25-28. The system 2500 is configured to prepare and deliver a locker 2501 full of products 2502 to a location for an event. The system 250 utilizes a calendar application operating on a user's device, as described in more detail below, to identify the event, the location, the time, and the attendees of the event.

The system 2500 stores information in one or more databases or other storage devices, although the databases described herein are referenced individually for clarity. The system 2500 includes a user database 2503 with user data stored thereon. The user data can include identification information, user device information, event preferences, device/calendar access permissions, and delivery preferences. The system 2500 further includes a product database 2504 with store data stored thereon. The store data can include inventory data, event data, and event product data. The system 2500 further includes an inventory and fulfillment database 2505 with data stored thereon pertaining to the event products, event locker(s), coordination of locker loading, delivery information, and so forth.

The system 2500 includes interacting control circuits to prepare and deliver the locker 2501. The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuits described herein may be configured (for example, by using corresponding programming stored in a memory as will be well understood by those skilled in the art) to carry out one or more of the steps, actions, and/or functions described herein.

A server 2506 or other control circuit operates as the central coordination device communicating with a user electronic device 2507, such as a smart phone, tablet, or other computing device. The user electronic device 2507 can be configured to operate a calendar or other scheduling application, configured as commonly understood. The calendar application allows a user to create and modify events or appointments. Further, the user can also utilize the calendar application to invite other people to the events by sending out invite messages to invitee devices 2508.

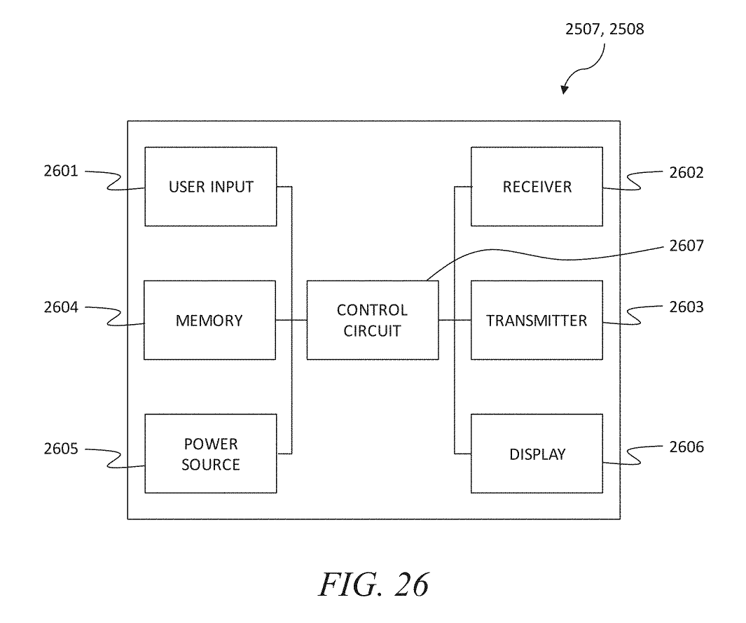

As shown in FIG. 26, the user electronic device 2507 and the attendee devices 2508 can include a user input 226016, such as a touch screen, keypad, switch device, voice command software, or the like, a receiver 2602, a transmitter 2603, which can both be incorporated within a transceiver, a memory 2604, a power source 2605, which can be replaceable or rechargeable as desired, a display 2606, and a control circuit 2607 controlling the operation thereof. The components of the user electronic device 2507 are connected by electrical pathways, such as wires, traces, circuit boards, and the like.

So configured, the user can create an event, which includes event information, such as a location and time of the event using the calendar application. The user can then enter or identify, such as from a contact list stored in the memory 2604, invitees to the event, send an invite to devices 2508 of the invitees through any suitable communication network 2509, including radio, the Internet, Bluetooth, near field, or the like, and receive responses from the invitee devices 40 indicating whether the invitees can attend the event or not.

Advantageously, the user can grant the server 2506 access to the user device 2507 or can configure the user device 2507 to automatically, or on command, send event data to the server 2506. In instances where the server 2506 can access the user device 2507, the server 2506 can monitor the calendar application for the creation of an event and responses from the invitee devices 2508. In some embodiments, the server 2506 can compile contact information for the invitees, from the event creation, responses, or contact list of the user electronic device 2507, for example, to directly communicate with the invitee devices 2508. Upon creation of the event, the server 2506 can begin the locker preparation process or can send a message to the user device 2507 asking the user whether the user would like the event to have a locker prepared. For example, the server 2506 can send a message, such as an email, text, pop-up notification, or the like, and the user can reply using the user input 2601.

As set forth above, the invitees respond to the invite by indicting whether or not they will attend the event. By a first approach, the server 2506 can monitor for the invitee response messages to create an attendee list of people attending the event. By a second approach, the user can command the user device 2507 to send the attendee list to the server 2506, which can be done after finalization, periodically, or as each response is received.

The server 2506 then creates a listing of products for the event. By one approach, the listing of products can be tailored specifically to the event. The combination of circumstances can be taken into account, such as the location, occasion, time, number/age of attendees, etc. In many cases, the type of event includes products typically associated with the event. In one example, if the event is outdoors and includes food, the products can include utensils, plates, napkins, etc. In another example, if the event requires food, the food can be tailored to the type of event, e.g., grilling food for tailgates, picnics, etc., cake or other desserts for a party, and so forth.

By another or further approach, the listing of products can be tailored to the user and/or the attendees. If desired, as set forth in more detail below, the products 2502 identified in the listing can additionally, or alternatively, be selected based on partiality vectors of the user and/or attendees. Further, the system 2500 can develop a listing for each attendee, the user included, groups of the attendees, or a single listing for the entire group. The system 2500 can assign listings in individual lockers, shared lockers, or a combination thereof to utilize space efficiently, for billing purposes, etc.

A delivery fulfillment facility 2510, such as a distribution center, store, or the like, includes one or more control circuits 2511. The control circuits 2511 are configured to access the inventory and fulfillment database 2505 to receive or retrieve the listing(s) of products. Thereafter, the delivery fulfillment facility 2510 is configured to prepare one or more lockers 2501 by collecting and packaging the products 2502 identified in the listing into the locker 2501 for delivery to a selected location, such as the event location or a location along a route of the user or other attendee. The delivery can further be scheduled for at or near a start time of the event, such as 15-30 minutes before, or other times as described in more detail below.

By some approaches, the delivery fulfillment facility 2510 includes automated machinery, which can include automated ground/air units, cranes, conveyance mechanisms, and so forth, to pick the products 2502 identified in the listing and package the products 2502 into the locker(s) 2502. In one example, the facility 2510 can be self-contained, similar to a vending machine, to pick the products 2501, put them in the locker(s) 2502, and output the ready locker(s) 2502. By other approaches, the delivery fulfillment facility 2510 can retrieve the listing and task workers with retrieving and packaging the products 2502 into the locker 2501. If desired, the facility 2510 can utilize both automated and manual operations.

After the locker 2501 is stocked with the products 2502 identified in the listing, the locker 2501 can then be loaded onto a delivery vehicle 2512 and delivered for the event. By a first approach, the delivery vehicle 2512 can deliver the locker 2501 to a docking station 2513. The docking station 2513 can be disposed at any suitable location, such as near or at the location of the event or along a travel route of the user or other attendee. The docking station 2513 can advantageously provide secure storage for the locker 2501 which allows for a larger delivery window for the facility 2510. Of course, the locker 2501 can also be equipped with components necessary for the products 2502 contained therein, such as a control circuit 2701 operating a temperature/atmosphere control system 2702 for perishable goods and so forth. Further, if the locker 2501 has electrical components, the locker 2501 can include a separate power source 2703 or can be powered by the docking station 2513 and/or delivery vehicle 2512 as needed. By a second approach, the delivery vehicle 2512 can deliver the locker 2501 directly to the user or other attendee at the location of the event during or before the time of the event.

Pursuant to this, the system 2500 can advantageously communicate with the user to schedule delivery of the locker 2501 or notify the user of the time and location of delivery. For example, the control circuit 2511 or server 2506 can send a message to the user electronic device 2507. If desired, the server 2506 can provide delivery options to the user electronic device 2507, such as delivery to the location of the event, delivery to a home or other location of the user prior to the event, delivery to a location along a travel route of the user, or the like. The user can then select one of the delivery options using the input 2601 and send a response message to the server 2506.

Additionally, as set forth above, the server 2506 can compile contact information for the attendees of the event. As such, the server 2506 can similarly notify, and receive responses, from the attendees about the time and location of the delivery, such as in situations where attendees are provided dedicated products 2502/lockers 2501.

In some instances, such as with the docking station 2513 or other remote delivery, it may be helpful if the locker 2501 is secured. Accordingly, the locker 2501 can include a locking mechanism 2704 and an interface 2705 configured to receive an access code or other entry to operate the locking mechanism 2704 and grant access to the products 2502 in the locker 2501. The interface 2705 can be configured with a keypad or other user input 2706. By one approach, the server 2506 sends an access code to the user electronic device 2507 and/or the attendee devices 2508 so that the user/attendee can enter the access code using the keypad 2706. By another approach, the server 2506 can send access rights data to the device 2507, 2508, such that the device 2507, 2508 can transmit the access rights data to the interface 2705 for authorized access. By a further approach, the user or attendee can save biometric data, e.g., eye scan, fingerprint, voice sample, and so forth, in the system 2500, such as in the user database 2503, and the user input 2706 can be a corresponding biometric input. The entry methods and/or locking mechanism 2704 can also be configured to restrict operation based on a timer. For example, the user can request that the locker 2501 not be opened until a given time, such as for a holiday, and the entry methods or locking mechanism 2704 will be configured to not operate until the given time.

The server 2506 can further coordinate for retrieval or delivery of the locker 2501 back to the facility 2510 or other location. In instances with a docking station 2513, the user can simply remove the products 2502 from the locker 2501 while it is attached to the docking station 2513 or can bring the locker 2501 back to the docking station 2513 after use to secure the locker 2501 thereto. The locker and/or docking station 2513 can be configured to transmit a signal to the facility 2510 and/or server 2506 indicating its location and status, such as secured to the docking station 2513. By other approaches, the user can message the system 2500, such as the facility 2510 or server 2506, with a desired drop-off time and location. Alternatively, the system 2500 can send one or more drop-off options, including a location and time, to the device 2507, 2508 and the user can select a desired option. Of course, a delivery vehicle 2512 can also be scheduled to retrieve the locker(s) 2501 at or near the end of the event at the location thereof.

The system 2500 can bill the user and/or attendee using any suitable method. By a first approach, the system 2500 can invoice the user and/or attendee for all of the products on the listing and included in the locker 2501. By a second approach, the system 2500 can determine which of the products 2502 were selected by the user/attendee during the event and invoice the user/attendee for the used products 2502. In either case, the system 2500 can transmit the bill to the appropriate device 2507, 2508 and/or cause a physical copy of the bill to be sent to a location in the contact information for the user/attendee.

In some embodiments, the system 2500 can advantageously utilize distributed computing power, allowing some actions to be performed on the user-side. For example, the server 2506 can maintain global information, including in the user database 2503, the product database 2504, and the inventory and fulfillment database 2505. The server 2506 further compiles the listing of products and connects with the supply chain to collect the products 2502, package the products 2502 in the locker 2501, and deliver the locker 2501 to the event.

Meanwhile, local computing power is provided by the user and/or attendee devices 2507, 2508. The local computing power is utilized to perform specifics for the event and managing the calendar and invite functions operating on the user electronic device 2507. For example, utilizing the user electronic device 2507, the user prepares the invite, compiles a list of invitees, and identifies event information, such as a theme/occasion, location, and time. The user then operates the user electronic device 2507 to transmit the invite and event information to the invitees. The user electronic device 2507 then sends one or more images, files containing all of this information, to the server 2506 so that the server 2506 can update the global information. Thereafter, the user electronic device 2507 receives acceptance messages or signals from one or more of the invitees and updates the invitees to attendees. The user electronic device 2507 can send images upon the reception of each response, after a set number of responses, after a predetermined amount of time has passed, after all invitees have responded, or combinations thereof.

As discussed above, the selection of products 2502 for the lockers 2501 can take the user's and, if desired, the other attendee's partiality vectors into account. Pursuant to this, the user database 2503 can have user profiles stored thereon that include information as set forth below. If an attendee does not have a corresponding profile, the system 2500 can prepare a template profile for the attendee based on publicly available information. For example, the server 2506 or other control circuit of the system 2500 can scan the Internet for information about the attendee, such as address, age, race, income level, employment status, marital status, and so forth, to compile the template profile. A template profile is described in U.S. Appl. No. 62/436,842, filed Dec. 20, 2016, which is hereby incorporated by reference herein.

In some embodiments, an event-based product locker preparation and delivery system is described herein that includes a user database configured to store user data comprising user event preferences, user calendar access permissions, and user delivery preferences, a product database configured to store data pertaining to events and corresponding products, and an inventory and fulfillment database configured to store data pertaining to the corresponding products and packaging of the corresponding products into at least one product locker configured for delivery to a location. The system further includes a server coupled to the user database, the product database, the inventory and fulfillment database. The server is configured to: receive or access an event created by a given user having data stored in the user database, the event created on an electronic user device using a calendar function and an invite list for the event, the event defined to occur at a given location at a given time period; receive indications from the electronic user device regarding attendance from the invite list to compile an attendee list; generate, using the data from the product database, a listing of products based on the event and the attendee list; and store the listing of products in the inventory and fulfillment database. The system further includes a delivery fulfillment facility coupled to the inventory and fulfillment database and configured to package products identified in the listing of products into a given locker for delivery to the given location during the given time period.

By several approaches, the user database can be further configured to store user partiality vector profiles; and the server can be configured to generate the listing of the products based on user partiality vector profiles corresponding to users identified in the attendee list. By further approaches, the server can be configured to prepare template partiality vector profiles for attendees identified in the attendee list without corresponding user partiality vector profiles stored in the user database based on publicly available information.

By some approaches, the server can be further configured to send a notification message to the user electronic device to inform the given user of the location and an expected time of delivery.

By several approaches, the given locker can include a user interface, and the server can be configured to send an access code to the user electronic device to send to or enter at the user interface to access the products within the given locker.

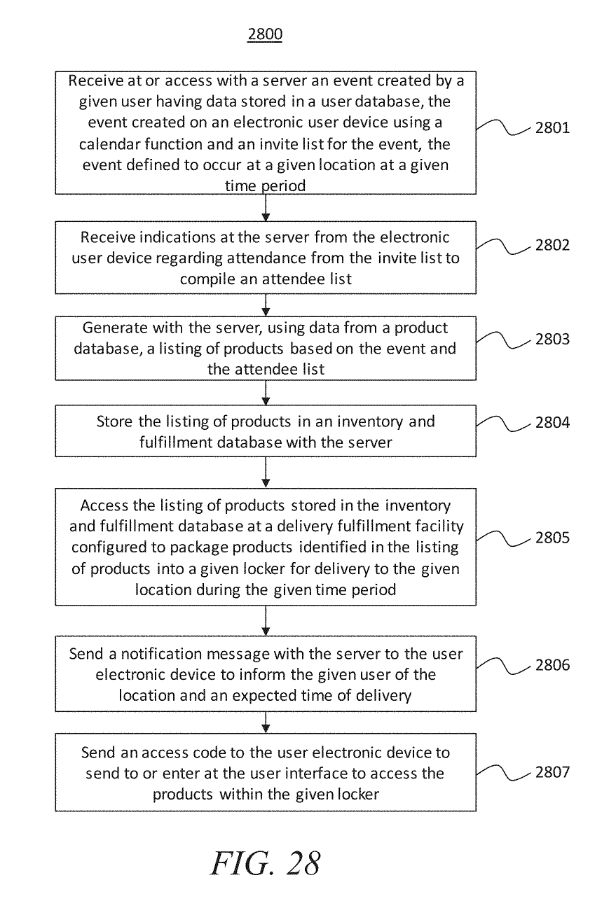

In several embodiments, a method 2800 illustrated in FIG. 28 for event-based package preparation is described herein that includes: receiving at or accessing with 2801 a server an event created by a given user having data stored in a user database, the event created on an electronic user device using a calendar function and an invite list for the event, the event defined to occur at a given location at a given time period, the user database configured to store user data comprising user event preferences, user calendar access permissions, and user delivery preferences; receiving 2802 indications at the server from the electronic user device regarding attendance from the invite list to compile an attendee list; generating 2803 with the server, using data from a product database, a listing of products based on the event and the attendee list, the product database configured to store data pertaining to events and corresponding products; storing 2804 the listing of products in an inventory and fulfillment database with the server, the inventory and fulfillment database configured to store data pertaining to the corresponding products and packaging of the corresponding products into at least one product locker configured for delivery to a location; and accessing 2805 the listing of products stored in the inventory and fulfillment database at a delivery fulfillment facility configured to package products identified in the listing of products into a given locker for delivery to the given location during the given time period.

By some approaches, generating 2803 the listing of products can further include generating the listing of products based on user partiality vector profiles corresponding to users identified in the attendee list stored in the user database. By further approaches, the method can include preparing templating partiality vector profiles with the server for attendees identified in the attendee lists without corresponding user partiality vector profiles stored in the user database based on publicly available information.

By several approaches, the method 2800 can further include sending 2806 a notification message with the server to the user electronic device to inform the given user of the location and an expected time of delivery.

By some approaches, the method 2800 can further include sending an invoice with the server to the user electronic device for the products included in the given locker.

By several approaches, the method 2800 can further include: determining with the server, after the event, which of the products were selected from the given locker; and sending an invoice with the server to the user electronic device for the products that were selected from the given locker.

By some approaches, the given locker can include a user interface, and the method 2800 can further include sending 2807 an access code to the user electronic device to send to or enter at the user interface to access the products within the given locker.

By several approaches, the method 2800 can further include: accessing the calendar application on the user electronic device with the server; and monitoring with the server for the creation of the event.

By another approach these teachings are useful to facilitate enable the dispensing of commercial items via commercial item containers. In some embodiments, such a system may include one or more database of information corresponding to one or more purchase opportunities and a plurality of partiality vectors as described herein (sometimes referred to as “PVs”). Each PV can characterize one of a characteristic of a target population (“population PV”) and an aspect of a commercial item (“commercial item PV”). Each purchase opportunity can include information corresponding to a commercial offer for a commercial item. Each commercial item container can be positioned at a location and may include one or more transceivers, volumes configured to temporarily store one or more commercial items, and control circuits communicatively coupled to the databases and the transceiver.

The target population can be positioned within a threshold distance of the commercial item container's location. The control circuits can be configured to assess at least one of the purchase opportunities using the plurality of PVs and as a result of the assessment thereby increase the probability that one or more consumers of the target population will participate in the assessed purchase opportunity. The control circuits can also be configured to cause one or more of the commercial item containers to transmit, via the transceiver(s), one or more delivery requests for each of the assessed purchase opportunities to one or more second control circuits for servicing, where each of the delivery requests can include information corresponding to a delivery destination that includes the location.

The method may include assessing at least one purchase opportunity for one or more commercial items using a plurality of PVs and thereby increasing the probability that at least one consumer of a target population will participate in the assessed purchase opportunity. The plurality of PVs may each characterize one of a partiality of the target population and an aspect of one of the commercial items. The target population can be positioned within a threshold distance of a location of a particular commercial item container. The method may also include causing the particular commercial item container to transmit, via a transceiver, at least one delivery request for the assessed purchase opportunity to one or more second control circuits for servicing, where each of the delivery requests can include information corresponding to a delivery destination comprising the location.

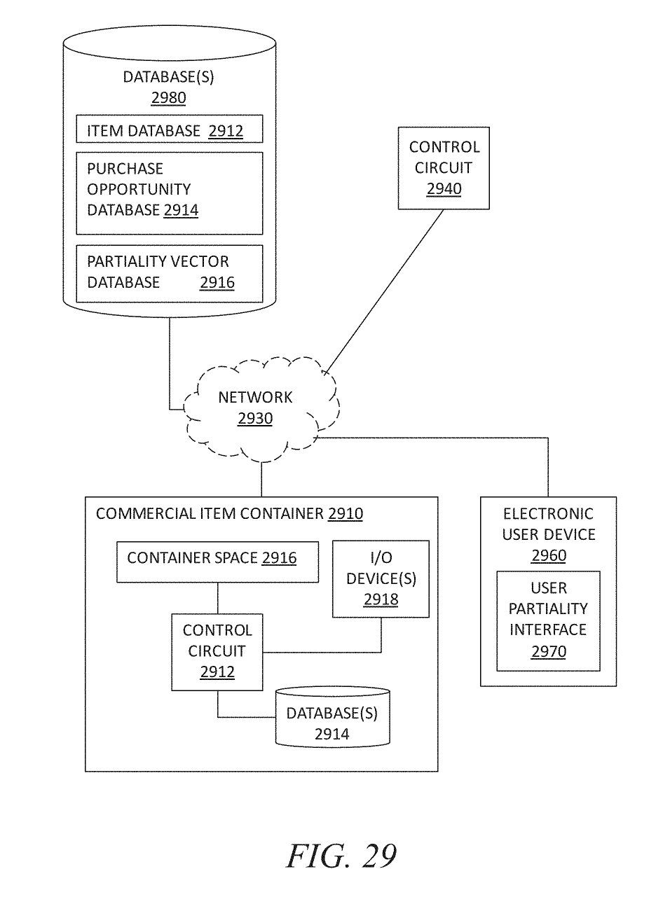

FIG. 29 illustrates a simplified block diagram of a system 2900 to enable dispensing of commercial items via commercial item containers, in accordance with some embodiments. System 2900 can comprise one or more electronic user devices 2960, control circuits 2940, databases 2980 and commercial item containers 2910 configured to communicate over a computer and/or one or more communication networks (“networks”) 2930.

Networks 2930 can be, for example, a local area network (LAN), a wide area network (WAN) such as the Internet, or a combination of the two, and includes wired, wireless, or fiber optic connections. In certain embodiments, networks 2930 may be networks 1310 (discussed above) or may be included therein and as such the commercial items containers 2910 may be communicatively coupled to memories 1303, 1306, or both. In general, network 2930 can be any combination of connections and protocols that can support communications between the commercial item containers 2910, electronic user devices 2960, databases 2980, and control circuits 2940, in accordance with some embodiments.

In some embodiments, the electronic user devices 2960 can be a desktop computer, a laptop computer, a thin client, a server, a cluster computer, a smart TV, an in-vehicle computing device, a wearable computing device, a mobile device (e.g., smart phones, phablets, tablets, and similar devices) or similar devices, among others. Electronic user devices 2960 can include one or more input/output devices that facilitate user interaction with the device (e.g., displays, speakers, microphones, keyboards, mice, touch screens, joysticks, dongles, pointing devices, game pads, cameras, gesture-based input devices, and similar I/O devices). In some embodiments, the user partiality interfaces 2970 may each be implemented on a particular electronic user device 2960. By one approach, an electronic user device 2960 may be associated with one or more consumers, customers, shoppers, pedestrians, similar persons of interest, or a combination of two or more thereof.

User partiality interface 2970 can include software that one or more consumers can use to access container space 2916 using one or more authentication methods that are known in the art and need not be repeated here. In some embodiments, the user partiality interface 2970 can be provided to the electronic user device 2960 by the control circuit 2912 and/or 2940. In some embodiments, the user partiality interface 2990 may be executed by the electronic user device 2960. Alternatively, the user partiality interface 2990 may be executed when in communication with the control circuit 2912. By one approach, user partiality interface 2970, for example, can include one or more graphical icons, visual indicators, and/or command-line indicators that allow consumers to interact with the user partiality interface 2970. Consumers can interact with the user partiality interface 2932 via manipulation of the electronic user device 2960, such as, for example, by manipulating graphical icons and/or visual indicators displayed on the electronic user device 2970. Additionally, or alternatively, consumers can interact with the user partiality interfaces 2970 by issuing one or more commands into the command-line interfaces. In some embodiments, user partiality interface 2970 can be configured to capture partiality information about the user stored on the electronic user device 2960 as discussed above.

In some embodiments, the control circuits 2940 can be associated with one or more commercial order management systems, control circuits, hardware and/or software components that support at least one activity and/or operation of commercial order management (e.g., entry, processing, validation, sourcing, pick, pack, ship, customer communications, change/cancel/update orders, etc.). In other implementations, the processes of the control circuits 2940 can be implemented through multiple systems, which may be geographically distributed and provide management over one or more warehouse locations. The control circuits 2940, in some applications, are communicatively coupled to one or more: management control circuits; inventory systems that tracks current and/or historic inventory at one or more warehouses; commercial item distribution management systems that utilizes received purchase opportunities for commercial items in defining how and when commercial items are distributed from the one or more warehouses; and other such management systems. In some embodiments, the control circuits 2940 are configured to service assessed purchase opportunities received from the commercial item containers 2910. By one approach, “servicing” assessed purchase opportunities can refer to the processing of the assessed purchase opportunity (e.g., invoicing, billing, sourcing, planning, picking/packing of commercial items, etc.) and arranging the delivery of the associated commercial item(s) to the appropriate commercial item container 2910 via one or more commercial delivery vehicles (e.g., manned, semi-autonomous, autonomous).

By one approach, the databases 2980 can include item database 2912, purchase opportunity database 2914, and/or partiality vector database, each of which may be a separate database communicatively coupled to the networks 2930. In certain embodiments, the partiality vector database 2916 can include the vectorized characterizations for commercial items (i.e., commercial item partiality vectors) and consumers (i.e., consumer partiality vectors) included in memories 1303 and 1306, respectively. As discussed above, partiality vectors can accommodate a variety of differing bases for such partialities including, for example, affinities, aspirations, preferences, and similar evaluative judgments. For example, partiality vector database(s) 2916 can receive one or more partiality vectors from control circuit 1301. In other embodiments, the partiality vector database(s) 2916 can be stored in memories 3114 (described below), database 2914, electronic user devices 2960, similar devices, or a combination of two or more thereof to form distributed database of partiality vectors. By one approach, the one or more control circuits 2912 can be configured (for example, by using corresponding programming as will be well understood by those skilled in the art) to carry out one or more of the steps, actions, processes, and/or functions described herein. As such, the partiality vector database(s) 2916 can comprise one or more partiality vectors generated by the control circuits 2912 as described above. One or more customer electronic user devices (e.g., electronic user devices 2960) may also be configured to carry out one or more of the steps, actions, and/or functions described herein. Additionally or alternatively, the one or more control circuits 2912 and the one or more electronic user devices 2960 can form a distributed processing system configured to carry out one or more of the steps, actions, and/or functions described herein.

In some embodiments, commercial item container 2910 can be configured to include one or more I/O devices 2918, databases 2914, transceivers 2980, and container spaces 2916 communicatively coupled to one or more control circuits 2912. The I/O devices 2918 can be devices configured to allow users to input text, characters, and other commands to control circuit 2912; display information in a pictorial/graphical form; emit audible outputs; capture one or more images using light visible to humans, infrared, etc.); send and/or receive data wirelessly via radio waves and/or optical signals; capture geospatial information related to commercial item container 2910; capture biometric/authentication data; similar input/output functionalities; or a combination of two or more thereof. In some embodiments, the commercial item containers 2910 can each be configured to have one or more container spaces 2916, which are three-dimensional volumes configured to temporarily store one or more commercial items (e.g., commercial items listed in item database 2912).

In certain embodiments, the container space 2916 can include climate control capabilities (e.g., temperature, humidity, and/or pressure control) and be configured to facilitate the storage of commercial items as dictated by their associated purchase opportunities. The commercial item containers 2910 can be configured to store one or more types of commercial items for sale (e.g., perishable and/or non-perishable food items, apparel items, consumables, and similar types of commercial objects) and can be temporarily or permanently established at predetermined locations (e.g., residential, commercial, collegiate, non-retail spaces, similar locations, or a combination of two or more thereof) frequented by persons of one or more particular demographics.

Purchase opportunity database 2914 may store therein one or more lists of one or more purchase opportunities. For example, purchase opportunities included in the one or more lists can be accessed on a first-in-first-out, a last-in-last-out basis, filtered based on one or more parameters, etc. Purchase opportunities can each include information that corresponds to a population and one or more commercial items.

Again, partiality vectors have both direction and magnitude. In certain embodiments, purchase opportunities are assessed to identify opportunities to increase the probability that one or more potential consumers in a threshold distance of the commercial item container 2910 (i.e. “the target population”) participate in the purchase opportunities. By one approach, such opportunities can be identified by ascertaining the one or more commercial objects having one or more partiality vectors that are aligned (i.e., have congruity) with the one or more partiality vectors of the targeted population. For example, if the demographic information (e.g., gender, age, academic status/achievements, income levels, marital statuses, occupations, religions, birth rate, death rate, average family size, average age at marriage, and/or postal code, similar demographic information, or a combination of two or more thereof) of the target population are known it may be useful to utilize a template that includes one or more partiality vectors that represent some statistical average or norm of other populations matching those same characterizing parameters. While it may be useful to at least begin to employ these teachings with certain target populations by using one or more such templates, these teachings will also accommodate modifying (perhaps significantly and perhaps quickly) such a starting point over time as part of developing a more personal set of partiality vectors that are specific to the targeted population. A variety of templates could be developed based, for example, on professions, academic pursuits and achievements, nationalities and/or ethnicities, characterizing hobbies, and the like.

Alignment values typically have a direct relationship with congruity. For example, the dot product of two partiality vectors can be defined by the following equation:

OPV·PPV=|OPV|cos θ·|PPV|

which corresponds to a scalar value defining the extent to which the commercial item partiality vector (OPV) coincides with the direction of the population partiality vector (PPV), and wherein θ· is the angle between OPV and PPV.

Thusly defined, the resulting scalar values are positive when the PPV and OPV pair are at least partially directed in the same direction. The scalar values are negative when the PPV and OPV pair are not at least partially directed in the same direction. Scalar values are neither positive nor negative (i.e., are equal to zero) when the PPV and OPV pair are orthogonal to each other. By one optional approach, an alignment value can reflect the dot product of a population PV and the related commercial item PV as defined above. Populations and commercial items may each be defined using one or more PPVs and OPVs, respectively. In embodiments where populations and commercial item are defined via one or more PPVs and OPVs, respectively, alignment values may be based on one or more dot products. Alignment values, in certain embodiments, may be based on the sum, average, difference, product, quotient, similar mathematical calculations, or a combination of two or more mathematical calculations of two or more differing dot product scalar values.

As discussed above, commercial items can be described using one or more characteristics (e.g., freshness, sourcing, material type, production type, ecological impact, similar characteristics, or a combination of two or more thereof). For example, a population may be characterized by PPV1 and PPV2 and a commercial object characterized by OPV1 and OPV2. Here, PPV1 and OPV1 can define a related characteristic (e.g., freshness) and PPV2 and OPV2 can define another related characteristic (e.g., sourcing). A first dot product (DP1) can be derived for PPV1 and OPV1 and a second dot product (DP2) can be derived for PPV2 and OPV2. The resultant alignment value can be defined as DP1, DP2, the average of DP1 and. DP2, or the sum of DP1 and DP2. Although alignment values based on a single dot product can be used, where two or more partiality vectors are available, alignment values that reflect the sum or average of dot products may provide the granular details that facilitate characterizing the alignment that supports identifying opportunities to increase the probability that one or more consumers of the population participate in the purchase opportunities. Other embodiments apply alignment rules from one or more rules databases and in part consider each alignment value relative to a corresponding alignment threshold before considering the vector. Similarly, a threshold number of alignment values having corresponding threshold values may have to be identified in determining whether there is sufficient alignment to indicate a determined probability that one or more consumers of the population will participate in a purchase opportunity and/or change future purchase habits.

For example, for purchase opportunities that include a particular commercial item (e.g., a gallon container of 2% milk) or type of product, one or more potential replacement commercial item included therein can be identified that have a threshold relationship to the commercial item (e.g., are similar in type to the commercial object) of the purchase opportunity (e.g., whole milk, almond milk, rice milk, organic 2% milk, unpasteurized milk, and other types/manufactures of milk). In some embodiments, potential replacement commercial item are identified in response to one or more alignment values (determined between product partiality vectors associated with the particular commercial and the customer's partiality vectors) that are less than one or more corresponding thresholds, a determination of a negative alignment of one or more corresponding item and population partiality vectors, an attempt to identify a item that may more likely be desired by one or more consumers of population, and/or other such conditions.

As one simple example, a meal plan may propose grilled chicken as a main course accompanied by broccoli, a tossed green salad, sliced peaches, and dinner rolls. Through an evaluation of partiality vectors, a negative alignment value with the grilled chicken (e.g., because the population consists of a majority (i.e. at least fifty-one percent) of vegans) may be identified. One or more potential replacement commercial items (e.g., a plant-based meat substitute) can be identified that can be delivered to the commercial item container 2910 in place of the original commercial item (i.e., the chicken) as at least part of a purchase opportunity to increase the probability of that one or more consumers of the population will participate in the purchase opportunity. In some embodiments, potential replacement commercial items can be identified by matching one or more characteristics (e.g., type, sourcing, ingredients, price, manufacturer ID, country of origin, similar characteristics). Identified potential replacement commercial items can be analyzed using partiality vectors as described herein.

For each potential replacement commercial item identified in item database 2912 (i.e., based on one or more applied rules, each particular type of milk having the appropriate volume), the control circuit 2910 accesses PVs associated with that potential replacement commercial item and PVs associated with the population. Based on one or more rules, the control circuit ascertains both the one or more PVs associated with that particular commercial object and the one or more PVs associated with the population identified in the purchase opportunity and generates one or more corresponding alignment values (as discussed above). One or more replacement commercial items, for example, having the highest generated alignment values, can be selected for delivery to the commercial item container 2910 that may correspond to the one or more replacement commercial items included in item database 2912 that are determined to have PVs that are aligned with the PVs of the population.

Similarly, one or more replacement commercial items may be identified based on a commercial item providing the highest number of alignment values that are greater than a threshold; may be identified based on one or more commercial items having a highest pair of alignment values; may be identified based on one or more commercial items having at least a first alignment value (e.g., associated with the original commercial item) greater than a first threshold and a second alignment value (e.g., associated with the replacement commercial item) greater than a second threshold; may be identified based on one or more commercial items having an alignment value within a standard deviation from a median value of a set of commercial item partiality vectors; or other such alignment value relationships based on one or more alignment rules. In certain embodiments, one or more replacement commercial items can share a threshold amount of characteristics with one or more commercial items. Some partiality vectors may further have priorities associated with them, and these priorities may indicate which corresponding alignment values are considered over other alignment values. In some embodiments, the control circuit further limits replacement commercial items to those commercial items that establish an alignment value that is greater than an alignment value between the original commercial item and the population replacement alignment value is greater than an alignment value of the partiality vector of the original commercial item and the population).

As discussed above, purchase opportunities are assessed to identify opportunities to include one or more replacement products in the purchase opportunities that may be likely to increase the probability that one or more consumers of the targeted population participate in the purchase opportunities. For example, one or more replacement products can be identified for some or all purchase opportunities generated, purchase opportunities that have a determined consumer participation rate below a threshold amount, purchase opportunities targeting a select group of consumers in a targeted population, other similar commercial bases, or a combination of two or more thereof. For example, a purchase opportunity for a meal plan may include a red wine for the beverage selection. When presented to the target population that have one or more partiality vectors aligned with sobriety (e.g., partiality vectors that reflect above average religious activity, consumption of certain prescription medications, being underage, or similar partialities), such partiality vectors have a poor alignment (e.g., opposite alignment or an alignment below a threshold amount) with red wine.

The purchase opportunity for the meal plan should therefore be changed to include one or more beverages that each have one or more partiality vectors that have an increased alignment with sobriety relative to the target population (e.g., sparkling water, iced tea, a juice, and/or other non-alcoholic beverage) compared to red wine. The aforementioned threshold amount by which replacement commercial items are identified can be set and selected as desired. By one approach, the threshold is static such that the same threshold is employed regardless of the circumstances. By another approach, the threshold is dynamic and can vary with such things as the quantity of PVs with which alignment values are based and/or the amount of data used to generate the PVs and/or the duration of time over which the data used to generate the PVs are available. In some embodiments, replacement commercial items can be characterized as having alignment values that have a statistically significant increase over the original commercial items. The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines.

By one approach, the population identified in some purchase opportunities may correspond to a plurality of persons located at or associated with a particular non-retail event (e.g., sporting event, musical concert/event, political event, and/or similar non-retail events) and/or non-retail locations (e.g., residential, commercial, collegiate, and/or similar non-retail locations). It is of course possible that partiality vectors may not be available yet for each population due to a lack of sufficient specific source information from or regarding that particular population. In this case it may nevertheless be possible to use one or more partiality vector templates that generally represent certain populations that fairly include a number (e.g., a threshold amount) of persons included in the particular target population. For example, if demographic information (e.g., gender, age, academic status/achievements, and/or postal code) of the target population is known it may be useful to utilize a template that includes one or more partiality vectors that represent some statistical average or norm of other populations matching those (or a threshold amount) same characterizing parameters.

Multiple populations can be identified that have a threshold relationship with one or more characterizing parameters. In some embodiments, partiality vectors for each of those populations can be accessed and used to determine template partiality vectors. For example, a first template partiality vector may be an average of the multiple first partiality vectors associated with two or more of the multiple populations. The template partiality vectors may be determined as a median vector, a range of vectors (e.g., within a standard deviation), an average once one or more outliers are removed from the calculation, and/or other such considerations. Further, other factors may be taken into account, such as one or more scalers, priorities of populations, distribution of individual partiality vectors, and/or other such factors.

Of course, while it may be useful to at least begin to employ these teachings with certain populations by using one or more such templates, these teachings will also accommodate modifying (perhaps significantly and perhaps quickly) such a starting point over time as part of developing a more personal set of partiality vectors that are specific to the population. For example, one or more such templates can be updated, amended, re-calculated when additional information specific to the populations is received (e.g., in PV database 2916, memory 1303, memory 1306, memory 3114, and/or another memory module communicatively coupled to network 2930). A variety of templates could be developed based, for example, on professions, academic pursuits and achievements, tax brackets, property taxes, nationalities and/or ethnicities, characterizing hobbies, and the like. By one approach, such templates may be stored in PV database 2916, memory 1306, memory 1303, memory 3114, and/or another memory module communicatively coupled to network 2930.

These teachings can be utilized to assess purchase opportunities for commercial item containers 2910 located in non-traditional retail spaces (e.g., business/office parks, residential areas, academic spaces, public spaces, and/or similar non-traditional retail spaces). For example, one or more commercial item containers 2910 may be located on or near a university campus attended by students of one or more particular demographics (e.g., age, gender, income, and/or similar characterizing parameters).

One or more PV templates each having one or more partiality vectors that represent some statistical average or norm of other populations matching those same characterizing parameters may be used to assess the one or more purchase opportunities used to stock commercial items in the commercial item containers 2910. In one approach, the commercial item containers 2910 can be frequented by a population of one or more particular demographics at particular time of the day and/or week. For example, working professionals (e.g., career-focused persons aged 25-55) may correspond to the majority (i.e., at least 51%) of those frequenting the commercial item containers 2910 between traditional working hours (e.g., 9 AM to 5 PM) on a particular weekday, while a socially inclined population (e.g., party goers, celebrators, merrymakers, revelers, roisterers, and/or similar individuals) may correspond to the majority of persons frequenting the commercial item containers 2910 during nights and/or weekends. Arguably, these two target populations may each correspond to a unique set of characterizing parameters. Hence, each unique set of characterizing parameters may be represented by one or more PV templates that generally represent certain populations that fairly include that particular target population. The one or more PV templates may be used to assess one or more purchase opportunities used to stock the commercial item containers 2910 on, for example, a time-specific basis.

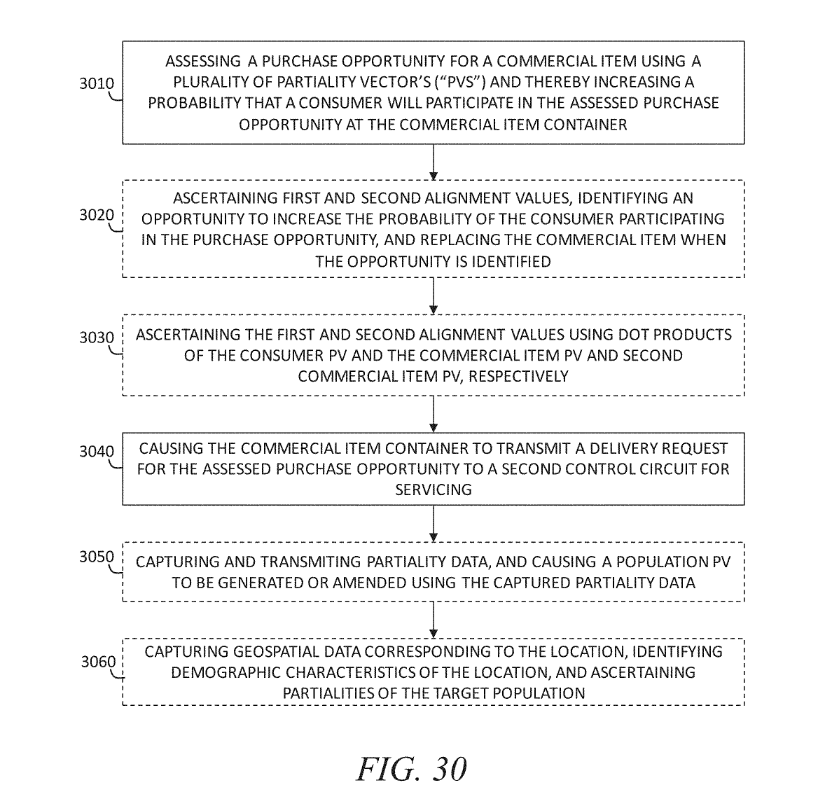

In particular, FIG. 30 illustrates the operational steps of dispensing of commercial items via commercial item containers. A purchase opportunity (e.g., of the purchase opportunity database 2914) for one or more commercial items (e.g., of the item database 2912) can be assessed at block 3010 using a plurality of PVs (e.g., of the partiality vector database 2916) to increase the probability that one or more consumers of a target population will participate in the assessed purchase opportunity. By one approach, the plurality of PVs can each characterize one of a partiality of the target population (“population PV”) and an aspect of the commercial item (“commercial item PV”). For example, the purchase opportunity can be assessed by ascertaining the congruity between the population PVs and the commercial item PVs. The target population can be positioned within a threshold distance of the location of the commercial item container 2910.

For example, geospatial data corresponding to the location of the commercial item container 2910 can be captured by one or more I/O devices 2918 and stored in one or more of the database 2914, database 2980, electronic user device 2960, memory 1303, memory 1306, memory 3114, a central computing system, similar storage locations, or a combination of two or more thereof. By one approach, the captured geospatial data can be used to identify one or more postal codes, geographic areas, addresses, and/or similar data (e.g., stored in one or more of the database 2914, database 2980, electronic user device 2960, memory 1303, memory 1306, memory 3114, a central computing system, similar storage locations, or a combination of two or more thereof) that are located within a threshold distance relative to the location of the commercial item container 2910. The threshold distance can be stored in database 2980, database 2914, a database communicatively coupled to the network 2930.

By one approach, the threshold distance is a dynamic value that can be determined by one or more of a central control system, the control circuit 2912, and the control circuit 2940, according to the type of commercial items to be stored in the commercial item container (e.g., perishable food items, non-perishable food items, apparel, consumables items, durable items, and/or similar commercial item types). Alternatively, the threshold distance can be static value set by a central control system, the control circuit 2912, or the control circuit 2940. “Zipcodes” can refer to geographic regions that can be defined by one or more demographic characteristics, which can be used to identify one or more population PVs associated with such characteristics (as discussed above).

One or more first alignment values and second alignment values can be ascertained at block 3020 to assess the purchase opportunity. Each first alignment value can correspond to a congruity between one of the population PVs and one of the commercial item PVs. Each second alignment value can correspond to a congruity between that particular population PV and a particular second commercial item PV that characterizes an aspect of a replacement commercial item. As discussed above, in response to ascertaining the alignment values, one or more opportunities to increase the probability of the one or more consumers of the target population participating in the purchase opportunity can be identified when a second alignment value is greater than a first alignment value by at least a threshold value. Each commercial item can be replaced with a particular replacement commercial item when the associated opportunity is identified.

At block 3030, ascertaining first alignment values and second alignment values can include ascertaining each first alignment value using a dot product of one of the population PVs and one of the commercial item PVs; and ascertaining each second alignment value using a dot product of the population PV and the second commercial item PV. At block 3040, the commercial item container 2910 can be caused to transmit (e.g., via an I/O device 2918) a delivery request for the assessed purchase opportunity to a second control circuit (e.g., one or more of the control circuits 2940, the control circuits 1301, central control circuits, and/or similar entities) for servicing, the delivery request comprising information corresponding to a delivery destination comprising the location. For example, the delivery request can reflect the one or more commercial items of the item database 2912 listed in the assessed purchase opportunity; the geospatial data corresponding to the location of the commercial item container 2910; date/time information; similar delivery-related information; or a combination of two or more thereof.

As discussed above, partiality data can be used to amend and/or generate population PVs to further characterize a give population. At block 3050, one or more user partiality interfaces 2970 can be configured to operate on one or more electronic user devices 2960 and each be caused to capture partiality data stored thereon and transmit (e.g., via the networks 2930) the captured partiality data to one or more control circuits (e.g., one or more of the control circuits 2912, control circuits 1301, processors 3112, central control circuits, etc.), where each of the electronic user devices 2960 and associated captured partiality data are associated with one of the consumers. The captured partiality data can be caused to be transmitted, via a transmitter (e.g., an I/O device 2918) communicatively coupled to the control circuit, to a second control circuit (e.g., one or more of the control circuits 2912, control circuits 1301, processors 3112, central control circuits, etc.) to thereby one of generate or amend one or more population PVs associated with the target population. For example, the generated or amended population PVs can be stored in the electronic user device 2960, and/or transmitted via the networks 2930 for storage in one or more of the databases 2914, databases 2980, memory 1303, memory 1300, memory 1303, memory 3114, central control systems, other databases communicatively coupled to the networks 2930, or a combination of two or more thereof.

As discussed, demographic data can be used to identify partialities that can be used to generate PVs. At block 3060, geospatial data corresponding to the location of the commercial item container 2910 can be captured (e.g., via one of the I/O devices 2918) and used to identify a plurality of demographic characteristics of consumers located within the threshold distance of the location. In some embodiments, captured geospatial data can be used to identify one or more postal codes, geographic areas, addresses, etc. located within the threshold distance of the commercial item container 2910 and the one or more associated demographic characteristics associated therewith (e.g., stored in one or more of the databases 2914, databases 2980, memory 1303, memory 1300, memory 1303, memory 3114, central control systems, other databases communicatively coupled to the networks 2930, or a combination of two or more thereof). For example, demographic data, which is typically categorized via postal code, geographic area, and/or address can be derived from a plurality of public data sources (e.g., town, city, state, country, municipal, academic, similar public data sources, or a combination of two or more thereof). At least a portion of the identified plurality of demographic characteristics can be used to ascertain a plurality of partialities of the target population, which includes the partialities of the target population discussed in block 3010.

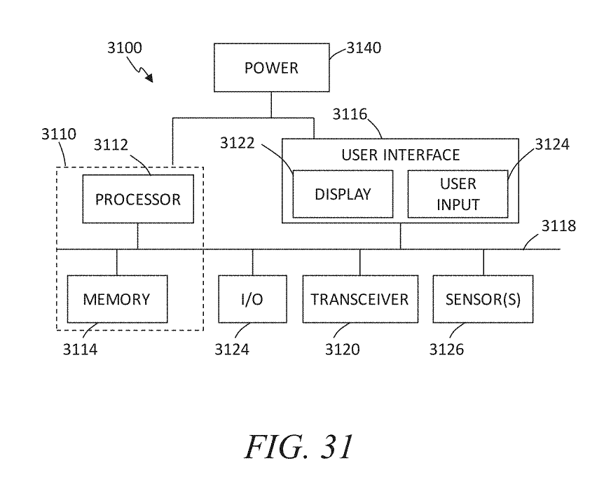

Further, the circuits, circuitry, systems, devices, processes, methods, techniques, functionality, services, servers, sources and the like described herein may be utilized, implemented and/or run on many different types of devices and/or systems. FIG. 31 illustrates an exemplary system 3100 that may be used for implementing any of the components, circuits, circuitry, systems, functionality, apparatuses, processes, or devices of the commercial item containers 2910, the electronic user devices 2960, the control circuits 2940, the control circuit 1301 and/or other above or below mentioned systems or devices, or parts of such circuits, circuitry, functionality, systems, apparatuses, processes, or devices. For example, the system 3100 may be used to implement some or all of the commercial item container 2910, one or more other control circuits and/or processing systems of the commercial item container 2910 (e.g., video processing systems, image processing systems, sensor data processing systems, emitter system, and the like), one or more remote central control systems, and/or other such components, circuitry, functionality and/or devices. However, the use of the system 3100 or any portion thereof is certainly not required.

By way of example, the system 3100 may comprise a control circuit or processor module 3112, memory 3114, and one or more communication links, paths, buses or the like 3118. Some embodiments may include one or more user interfaces 3116, and/or one or more internal and/or external power sources or supplies 3140. The control circuit 3112 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in sonic embodiments, the control circuit 3112 can be part of control circuitry and/or a control system 3110, which may be implemented through one or more processors with access to one or more memory 3114 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 3100 may be used to implement one or more of the above or below, or parts of, components, circuits, systems, processes and the like.

The user interface 3116 can allow a user to interact with the system 3100 and receive information through the system. In some instances, the user interface 3116 includes a display 3122 and/or one or more user inputs 3124, such as buttons, touch screen, track ball, keyboard, mouse, etc., which can be part of or wired or wirelessly coupled with the system 3100. Typically, the system 3100 further includes one or more communication interfaces, ports, transceivers 3120 and the like allowing the system 3100 to communicate over a communication bus, a distributed computer and/or communication network 2930 (e.g., a local area network (LAN), the Internet, wide area network (WAN), etc.), communication link 3118, other networks or communication channels with other devices and/or other such communications or combination of two or more of such communication methods. Further the transceiver 3120 can be configured for wired, wireless, optical, fiber optical cable, satellite, or other such communication configurations or combinations of two or more of such communications. Some embodiments include one or more input/output (I/O) ports 2034 that allow one or more devices to couple with the system 3100. The I/O ports can be substantially any relevant port or combinations of ports, such as but not limited to USB, Ethernet, or other such ports. The I/O interface 2034 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 3126 to provide information to the system and/or sensor information that is communicated to another component, such as the central control system, control circuits 2912, control circuits 2940, electronic user devices 2960 etc. One or more sensors 3126 can be implemented through one or more I/O devices 2918. The sensors can include substantially any relevant sensor, such as distance measurement sensors (e.g., optical units, sound/ultrasound units, etc.), cameras, motion sensors, inertial sensors, climate sensors (e.g., temperature, humidity, pressure, etc.), accelerometers, impact sensors, pressure sensors, geopositional sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 3100 comprises an example of a control and/or processor-based system with the control circuit 3112. Again, the control circuit 3112 can be implemented through one or more processors, controllers, central processing units, logic, software and the like. Further, in some implementations the control circuit 1012 may provide multiprocessor functionality.

The memory 3114, which can be accessed by the control circuit 3112, typically includes one or more processor readable and/or computer readable media accessed by at least the control circuit 3112, and can include volatile and/or nonvolatile media, such as RAM, ROM, EEPROM, flash memory and/or other memory technology. Further, the memory 3114 is shown as internal to the control system 3110; however, the memory 3114 can be internal, external or a combination of internal and external memory. Similarly, some or all of the memory 3114 can be internal, external or a combination of internal and external memory of the control circuit 3112. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 2930. The memory 3114 can store code, software, executables, scripts, data, content, lists, programming, programs, log or history data, commercial item information, purchase opportunities, partiality vectors, and the like. While FIG. 20 illustrates the various components being coupled together via a bus, it is understood that the various components may actually be coupled to the control circuit and/or one or more other components directly.

In some embodiments, a system and a corresponding method performed by the system, comprises: enable dispensing of commercial items via commercial item containers. In some embodiments, the system may include one or more database of information corresponding to one or more purchase opportunities and a plurality of partiality vectors (“PVs”). Each PV can characterize one of a characteristic of a target population (“population PV”) and an aspect of a commercial item (“commercial item PV”). Each purchase opportunity can include information corresponding to a commercial offer for a commercial item. Each commercial item container can be positioned at a location and may include one or more transceivers, volumes configured to temporarily store one or more commercial items, and control circuits communicatively coupled to the databases and the transceiver.

The target population can be positioned within a threshold distance of the commercial item container's location. The control circuits can be configured to assess at least one of the purchase opportunities using the plurality of PVs and as a result of the assessment thereby increase the probability that one or more consumers of the target population will participate in the assessed purchase opportunity. The control circuits can also be configured to cause one or more of the commercial item containers to transmit, via the transceiver(s), one or more delivery requests for each of the assessed purchase opportunities to one or more second control circuits for servicing, where each of the delivery requests can include information corresponding to a delivery destination that includes the location.

The method may include assessing at least one purchase opportunity for one or more commercial items using a plurality of PVs and thereby increasing the probability that at least one consumer of a target population will participate in the assessed purchase opportunity. The plurality of PVs may each characterize one of a partiality of the target population and an aspect of one of the commercial items. The target population can be positioned within a threshold distance of a location of a particular commercial item container. The method may also include causing the particular commercial item container to transmit, via a transceiver, at least one delivery request for the assessed purchase opportunity to one or more second control circuits for servicing, where each of the delivery requests can include information corresponding to a delivery destination comprising the location.

By some further approaches the above-described teachings can be fairly represented by one or more of these characterizing statements.

Some embodiments provide (1) an apparatus comprising: an enterprise-accessible customer locker physically located at a customer's address; a control circuit configured to: -select unordered products for the customer to be placed in the enterprise-accessible customer locker; - determine a need to deliver a particular product to a second customer, the second customer being physically discrete from the customer's address; - arrange to transfer the particular product from the enterprise-accessible customer locker to the second customer at a delivery address corresponding to the second customer.

Further, 2. The apparatus of characterization 1 wherein the enterprise-accessibly customer locker comprises one of: a secure-delivery receptacle that corresponds to the customer's address; an unattended retail storefront installed in the customer's residence at the customer's address. 3. The apparatus of characterization 1 wherein the control circuit is configured to select the unordered products for the customer as a function, at least in part, of: information including a plurality of partiality vectors for the customer; and vectorized characterizations for each of a plurality of products, wherein each of the vectorized characterizations indicates a measure regarding an extent to which a corresponding one of the products accords with a corresponding one of the plurality of partiality vectors. 4. The apparatus of characterization 1 wherein the control circuit is configured to determine the need to deliver the particular product to the second customer, at least in part, as a function of an order placed on behalf of the second customer. 5. The apparatus of characterization 1 wherein the control circuit is configured to determine the need to deliver the particular product to the second customer, at least in part, as a function of: information including a plurality of partiality vectors for the second customer; and vectorized characterizations for each of a plurality of products, wherein each of the vectorized characterizations indicates a measure regarding an extent to which a corresponding one of the products accords with a corresponding one of the plurality of partiality vectors. 6. The apparatus of characterization 5 wherein the partiality vectors include at least one partiality vector that is knowingly based upon at least one value of the second customer. 7. The apparatus of characterization 6 wherein the at least one partiality vector that is knowingly based upon at least one value of the second customer is not based upon any previous purchase of the second customer. 8. The apparatus of characterization 1 wherein the control circuit is configured to arrange to transfer the particular product from the enterprise-accessible customer locker to the second customer by automatically tasking a delivery agent with transferring the particular product. 9. The apparatus of characterization 8 wherein tasking the delivery agent comprises automatically sending a message to so task the delivery agent. 10. The apparatus of characterization 9 wherein the message includes information to unlock the enterprise-accessible customer locker. 11. The apparatus of characterization 8 wherein the delivery agent is a third party with respect to the enterprise. 12. The apparatus of characterization 8 wherein the delivery agent comprises an autonomous delivery agent. 13. The apparatus of characterization 1 wherein the control circuit is further configured to: determine that the particular product is presently available at the enterprise-accessible customer locker. 14. The apparatus of characterization 13 wherein the control circuit is further configured to: determine that the customer will not likely need the particular product for at least a predetermined period of time. 15. The apparatus of characterization 14 wherein the control circuit is further configured to determine that the customer will not likely need the particular product for at least the predetermined period of time as a function, at least in part, of: information including a plurality of partiality vectors for the customer; and vectorized characterizations for the particular product, wherein each of the vectorized characterizations indicates a measure regarding an extent to which the particular product accords with a corresponding one of the plurality of partiality vectors. 16. The apparatus of characterization 13 wherein the control circuit is further configured to: arrange for a replacement product for the particular product to be placed in the enterprise-accessible customer locker prior to when the customer will likely need the particular product.

Some embodiments provide (17.) a vending apparatus comprising: a housing containing products available to be vended via the vending apparatus; wireless data interface; a control circuit disposed within the housing and operably coupled to the wireless data interface, the control circuit being configured to: - wirelessly communicate via the wireless data interface with local user devices to thereby receive at least one personalizing identifier; - automatically employ the personalizing identifier to facilitate future product stocking selections for the vending apparatus.

Further, 18. The vending apparatus of characterization 17 wherein employing the personalizing identifier to facilitate future product stocking selections for the vending apparatus comprises, at least in part: correlating the personalizing identifier to a particular person; accessing previously-stored partiality information for the particular person; using the partiality information for the particular person to select products from amongst a plurality of candidate products to stock in the vending apparatus. 19. The vending apparatus of characterization 18 wherein the previously-stored partiality information for the particular person comprises, at least in part, a plurality of partiality vectors for the particular person wherein each of the partiality vectors has at least one of a length and an angle that corresponds to a magnitude of the particular person's belief in an amount of good that comes from an order associated with a corresponding partiality. 20. The vending apparatus of characterization 19 wherein using the partiality information for the particular person to select products from amongst the plurality of candidate products to stock in the vending apparatus comprises, at least in part, using vectorized characterizations for each of the plurality of candidate products, wherein each of the vectorized characterizations indicates a measure regarding an extent to which a corresponding one of the candidate products accords with a corresponding one of the plurality of partiality vectors. 21. The vending apparatus of characterization 17 wherein automatically employ the personalizing identifier to facilitate future product stocking selections for the vending apparatus comprises, at least in part: maintaining a count of a number of episodes during which the personalizing identifier is received from the user device; conditioning the automatic employment of the personalizing identifier to facilitate future product stocking selections for the vending apparatus as a function, at least in part, of the count, such that stocking selections are weighted more heavily in favor of a higher count. 22. The vending apparatus of characterization 17 wherein maintaining the count comprises maintaining the count for a predetermined window of time. 23. The vending apparatus of characterization 17 wherein the personalizing information includes, at least in part, partiality information for the particular person and wherein automatically employing the personalizing identifier to facilitate future product stocking selections for the vending apparatus includes, at least in part, using the partiality information to facilitate future product stocking selections for the vending apparatus. 24. The vending apparatus of characterization 23 wherein the partiality information for the particular person comprises, at least in part, a plurality of partiality vectors for the particular person wherein each of the partiality vectors has at least one of a length and an angle that corresponds to a magnitude of the particular person's belief in an amount of good that comes from an order associated with a corresponding partiality. 25. The vending apparatus of characterization 24 wherein using the partiality information to facilitate future product stocking selections for the vending apparatus comprises, at least in part, using vectorized characterizations for each of a plurality of candidate products, wherein each of the vectorized characterizations indicates a measure regarding an extent to which a corresponding one of the candidate products accords with a corresponding one of the plurality of partiality vectors. 26. The vending apparatus of characterization 17 wherein the control circuit is further configured to: wirelessly transmit to the user device a blockchain-based token corresponding to a vendable product at the vending apparatus. 27. The vending apparatus of characterization 26 wherein the blockchain-based token comprises an opportunity to receive the vendable product at the vending apparatus without cost. 28. The vending apparatus of characterization 26 wherein the control circuit is further configured to: correlate the personalizing identifier to a particular person; access previously-stored partiality information for the particular person; use the partiality information for the particular person to select the vendable product from amongst a plurality of candidate products to offer to the particular person via the blockchain-based token.

Some embodiments provide (29.) a method for use with a vending apparatus having a housing containing products available to be vended via the vending apparatus, a wireless data interface, and a control circuit disposed within the housing and operably coupled to the wireless data interface, the method comprising: by the control circuit: wirelessly communicating via the wireless data interface with local user devices to thereby receive at least one personalizing identifier; automatically employing the personalizing identifier to facilitate future product stocking selections for the vending apparatus.

Further, 30. The method of characterization 29 wherein employing the personalizing identifier to facilitate future product stocking selections for the vending apparatus comprises, at least in part: correlating the personalizing identifier to a particular person; accessing previously-stored partiality information for the particular person; using the partiality information for the particular person to select products from amongst a plurality of candidate products to stock in the vending apparatus. 31. The method of characterization 30 wherein the previously-stored partiality information for the particular person comprises, at least in part, a plurality of partiality vectors for the particular person wherein each of the partiality vectors has at least one of a length and an angle that corresponds to a magnitude of the particular person's belief in an amount of good that comes from an order associated with a corresponding partiality. 32. The method of characterization 29 wherein automatically employ the personalizing identifier to facilitate future product stocking selections for the vending apparatus comprises, at least in part: maintaining a count of a number of episodes during which the personalizing identifier is received from the user device; conditioning the automatic employment of the personalizing identifier to facilitate future product stocking selections for the vending apparatus as a function, at least in part, of the count, such that stocking selections are weighted more heavily in favor of a higher count. 33. The method of characterization 29 wherein the personalizing information includes, at least in part, partiality information for the particular person and wherein automatically employing the personalizing identifier to facilitate future product stocking selections for the vending apparatus includes, at least in part, using the partiality information to facilitate future product stocking selections for the vending apparatus. 34. The method of characterization 29 further comprising: wirelessly transmitting to the user device a blockchain-based token corresponding to a vendable product at the vending apparatus. 35. The method of characterization 34 wherein the blockchain-based token comprises an opportunity to receive the vendable product at the vending apparatus without cost. 36. The method of characterization 34 further comprising: correlating the personalizing identifier to a particular person; accessing previously-stored partiality information for the particular person; using the partiality information for the particular person to select the vendable product from amongst a plurality of candidate products to offer to the particular person via the blockchain-based token.

Some embodiments provide (37.) an event-based product locker preparation and delivery system, the system comprising: a user database configured to store user data comprising user event preferences, user calendar access permissions, and user delivery preferences; a product database configured to store data pertaining to events and corresponding products; an inventory and fulfillment database configured to store data pertaining to the corresponding products and packaging of the corresponding products into at least one product locker configured for delivery to a location; a server coupled to the user database, the product database, the inventory and fulfillment database, the server configured to: receive or access an event created by a given user having data stored in the user database, the event created on an electronic user device using a calendar function and an invite list for the event, the event defined to occur at a given location at a given time period; receive indications from the electronic user device regarding attendance from the invite list to compile an attendee list; generate, using the data from the product database, a listing of products based on the event and the attendee list; store the listing of products in the inventory and fulfillment database; a delivery fulfillment facility coupled to the inventory and fulfillment database and configured to package products identified in the listing of products into a given locker for delivery to the given location during the given time period.

Further, 38. The system of characterization 37, wherein the user database is further configured to store user partiality vector profiles; and the server configured to generate the listing of the products further comprises the server configured to generate the listing of the products based on user partiality vector profiles corresponding to users identified in the attendee list. 39. The system of characterization 38, wherein the server is further configured to prepare template partiality vector profiles for attendees identified in the attendee list without corresponding user partiality vector profiles stored in the user database based on publicly available information. 40. The system of characterization 39, wherein the server configured to generate the listing of products further comprises the server configured to generate the listing of products based on a group partiality vector profile taking into account the user partiality vector profiles and the template partiality vector profiles. 41. The system of characterization 39, wherein the given locker comprises a plurality of product lockers; and the server configured to generate the listing of products further comprises the server configured to generate listings of products for each of the plurality of product lockers based on individual ones of the user partiality vector profiles or the template partiality vector profiles. 42. The system of characterization 37, wherein the server is further configured to send a notification message to the user electronic device to inform the given user of the location and an expected time of delivery. 43. The system of characterization 32, wherein the server is further configured to send an invoice to the user electronic device for the products included in the given locker. 44. The system of characterization 42, wherein the server is further configured to: determine, after the event, which of the products were selected from the given locker; and send an invoice to the user electronic device for the products that were selected from the given locker. 45. The system of characterization 37, wherein the given locker includes a user interface, and the server is configured to send an access code to the user electronic device to send to or enter at the user interface to access the products within the given locker. 46. The system of characterization 37, wherein the server is configured to access the calendar application on the user electronic device and monitor for the creation of the event.

Some embodiments provide (47.) a method for event-based package preparation, the method comprising: receiving at or accessing with a server an event created by a given user having data stored in a user database, the event created on an electronic user device using a calendar function and an invite list for the event, the event defined to occur at a given location at a given time period, the user database configured to store user data comprising user event preferences, user calendar access permissions, and user delivery preferences; receiving indications at the server from the electronic user device regarding attendance from the invite list to compile an attendee list; generating with the server, using data from a product database, a listing of products based on the event and the attendee list, the product database configured to store data pertaining to events and corresponding products; storing the listing of products in an inventory and fulfillment database with the server, the inventory and fulfillment database configured to store data pertaining to the corresponding products and packaging of the corresponding products into at least one product locker configured for delivery to a location; accessing the listing of products stored in the inventory and fulfillment database at a delivery fulfillment facility configured to package products identified in the listing of products into a given locker for delivery to the given location during the given time period.

Further, 48. The method of characterization 47, wherein generating the listing of products further comprises generating the listing of products based on user partiality vector profiles corresponding to users identified in the attendee list stored in the user database. 49. The method of characterization 48, further comprising preparing templating partiality vector profiles with the server for attendees identified in the attendee lists without corresponding user partiality vector profiles stored in the user database based on publicly available information, 50. The method of characterization 49, wherein generating the listing of products further comprises generating the listing of products based on a group partiality vector profile taking into account the user partiality vector profiles and the template partiality vector profiles. 51. The method of characterization 49, wherein generating the listing of products further comprises generating listings of products for a plurality of the attendees based on corresponding user partiality vector profiles or corresponding template partiality vector profiles; storing the listing of products in the inventory and fulfillment database comprises storing the listings of products in the inventory and fulfillment database; and accessing the listing of products stored in the inventory and fulfillment database at the delivery fulfillment facility comprises accessing the listings of products stored in the inventory and fulfillment database at the delivery fulfillment facility configured to package products identified in the listings of products into a plurality of given lockers for delivery to the given location during the given time period. 52. The method of characterization 47, further comprising sending a notification message with the server to the user electronic device to inform the given user of the location and an expected time of delivery. 53. The method of characterization 47, further comprising sending an invoice with the server to the user electronic device for the products included in the given locker. 54. The method of characterization 47, further comprising: determining with the server, after the event, which of the products were selected from the given locker; and sending an invoice with the server to the user electronic device for the products that were selected from the given locker. 55. The method of characterization 47, wherein given locker includes a user interface, and the method further comprises sending an access code to the user electronic device to send to or enter at the user interface to access the products within the given locker. 56. The method of characterization 47, further comprising: accessing the calendar application on the user electronic device with the server; and monitoring with the server for the creation of the event.

Some embodiments provide (57.) a system to enable dispensing of commercial items via commercial item containers comprising: a database of information corresponding to a purchase opportunity and a plurality of partiality vectors (“PVs”) each characterizing one of a characteristic of a target population (“population PV”) and an aspect of a commercial item (“commercial item PV”), the purchase opportunity comprising information corresponding to a commercial offer for a commercial item; and a commercial item container positioned at a location and comprising: a transceiver; a volume configured to temporarily store one or more commercial items; and a control circuit communicatively coupled to the database and the transceiver, and configured to: assess a purchase opportunity using the plurality of PVs and thereby increase a probability that a consumer of the target population will participate in the assessed purchase opportunity, the target population positioned within a threshold distance of the location; and cause the commercial item container to transmit, via the transceiver, a delivery request for the assessed purchase opportunity to a second control circuit for servicing, the delivery request comprising information corresponding to a delivery destination comprising the location.

Further, 58. The system of characterization 57, wherein in assessing the purchase opportunity the control circuit is configured to: ascertain a first alignment value and a second alignment value, the first alignment value corresponding to a congruity of the population PV and the commercial item PV, the second alignment value corresponding to a congruity of the population PV and a second commercial item PV that characterizes an aspect of a replacement commercial item; identify an opportunity to increase a probability of the consumer participating in the purchase opportunity when the second alignment value is greater than the first alignment value by at least a threshold value; and cause the commercial item to be replaced with the replacement commercial item when the opportunity is identified. 59. The system of characterization 58, wherein the control circuit is configured to: ascertain the first alignment value using a dot product of the population PV and the commercial item PV; and ascertain the second alignment value using a dot product of the population PV and the second commercial item PV. 60. The system of characterization 57, further comprising a user partiality interface configured to operate on an electronic user device associated with the consumer; wherein the control circuit is communicatively coupled to the electronic user device and configured to: cause the user partiality interface to capture partiality data stored thereon and transmit the captured partiality data to the control circuit via the transceiver; and cause a population PV associated with the target population to be one of generated and amended using the captured partiality data. 61. The system of characterization 57, wherein the control circuit is configured to: capture geospatial data corresponding to the location of the commercial item container; and use the captured geospatial data to identify a plurality of demographic characteristics of consumers located within the threshold distance of the location and thereby ascertain a plurality of partialities of the target population, the partiality of the target population included in the plurality of partialities of the target population. 62. The system of characterization 61, wherein a PV of the plurality of PVs that characterizes a partiality of the target population corresponds to one of the following: an average value of a sum of a plurality of PV templates that correspond to populations comprising a threshold amount of consumers included in the target population; a median value of the plurality of PV templates; an average value of the sum that is within a threshold standard deviation; and an average value of the sum that is within a threshold range of values.

Some embodiments provide (63.) a method of enabling dispensing of commercial items via commercial item containers, comprising: assessing, via a control circuit, a purchase opportunity for a commercial item using a plurality of partiality vector's (“PVs”) and thereby increasing a probability that a consumer of a target population will participate in the assessed purchase opportunity, the plurality of PVs each characterizing one of a partiality of the target population (“population PV”) and an aspect of the commercial item (“commercial item PV”), the target population positioned within a threshold distance of a location of the commercial item container; and causing, via the control circuit, the commercial item container to transmit, via a transceiver communicatively coupled to the control circuit, a delivery request for the assessed purchase opportunity to a second control circuit for servicing, the delivery request comprising information corresponding to a delivery destination comprising the location.

Further, 64. The method of characterization 63, wherein assessing the purchase opportunity comprises: ascertaining, via the control circuit, a first alignment value and a second alignment value, the first alignment value corresponding to a congruity of the population PV and the commercial item PV, the second alignment value corresponding to a congruity of the population PV and a second commercial item PV that characterizes an aspect of a replacement commercial item; identifying, via the control circuit, an opportunity to increase a probability of the consumer participating in the purchase opportunity when the second alignment value is greater than the first alignment value by at least a threshold value; and causing, via the control circuit, the commercial item to be replaced with the replacement commercial item when the opportunity is identified. 65. The method of characterization 63, wherein ascertaining the first alignment value and the second alignment value comprises: ascertaining, via the control circuit, the first alignment value using a dot product of the population PV and the commercial item PV; and ascertaining, via the control circuit, the second alignment value using a dot product of the population PV and the second commercial item PV. 66. The method of characterization 63, further comprising: causing, via the control circuit, a user partiality interface configured to operate on an electronic user device to capture partiality data stored thereon and transmit the captured partiality data to the control circuit, the electronic user device and the captured partiality data each associated with the consumer; and causing, via the control circuit, the captured partiality data to be transmitted, via a transmitter communicatively coupled to the control circuit, to a second control circuit to thereby one of generate or amend a population PV associated with the target population. 67. The method of characterization 63, further comprising: capturing, via a sensor communicatively coupled to the control circuit, geospatial data corresponding to the location of the commercial item container; and using, via the control circuit, the captured geospatial data to identify a plurality of demographic characteristics of consumers located within the threshold distance of the location and thereby ascertain a plurality of partialities of the target population, the partiality of the target population included in the plurality of partialities of the target population. 68. The method of characterization 63, wherein a population PV corresponds to one of the following: an average value of a sum of a plurality of PV templates that correspond to populations comprising a threshold amount of consumers included in the target population; a median value of the plurality of PV templates; an average value of the sum that is within a threshold standard deviation; and an average value of the sum that is within a threshold range of values.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed. Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; 15/487,760 filed Apr. 14, 2017; 15/487,538 filed Apr. 14, 2017; 15/487,775 filed Apr. 14, 2017; 15/488,107 filed Apr. 14, 2017; 15/488,015 filed Apr. 14, 2017; 15/487,728 filed Apr. 14, 2017; 15/487,882 filed Apr. 14, 2017; 15/487,826 filed Apr. 14, 2017; 15/487,792 filed Apr. 14, 2017; 15/488,004 filed Apr. 14, 2017; 15/487,894 filed Apr. 14, 2017; 62/486,801, filed Apr. 18. 2017; 62/510,322, filed May 24, 2017; 62/510,317, filed May 24, 2017; 15/606,602, filed May 26, 2017; 62/513,490, filed Jun. 1, 2017; 15/624,030 filed Jun. 15, 2017; 15/625,599 filed Jun. 16, 2017; 15/628,282 filed Jun. 20, 2017; 62/523,148 filed Jun. 21, 2017; 62/525,304 filed Jun. 27, 2017; 15/634,862 filed Jun. 27, 2017; 62/527,445 filed Jun. 30, 2017; 15/655,339 filed July 20, 2017; 15/669,546 filed Aug. 4, 2017; and 62/542,664 filed Aug. 8, 2017; 62/542,896 filed Aug. 9, 2017; 15/678,608 filed Aug. 16, 2017; 62/548,503 filed Aug. 22, 2017; 62/549,484 filed Aug. 24, 2017; 15/685,981 filed Aug. 24, 2017; 62/558,42.0 filed Sep. 14, 2017; 15/704,878 filed Sep. 14, 2017; and 62/559,128 filed Sep. 15, 2017.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
an enterprise-accessible customer locker physically located at a customer's address;
a control circuit configured to:
select unordered products for the customer to be placed in the enterprise-accessible customer locker;
determine a need to deliver a particular product to a second customer, the second customer being physically discrete from the customer's address;
arrange to transfer the particular product from the enterprise-accessible customer locker to the second customer at a delivery address corresponding to the second customer.

2. The apparatus of claim 1 wherein the enterprise-accessible customer locker comprises one of:
a secure-delivery receptacle that corresponds to the customer's address;
an unattended retail storefront installed in the customer's residence at the customer's address.

3. The apparatus of claim 1 wherein the control circuit is configured to select the unordered products for the customer as a function, at least in part, of:
information including a plurality of partiality vectors for the customer; and
vectorized characterizations for each of a plurality of products, wherein each of the vectorized characterizations indicates a measure regarding an extent to which a corresponding one of the products accords with a corresponding one of the plurality of partiality vectors.

4. The apparatus of claim 1 wherein the control circuit is configured to determine the need to deliver the particular product to the second customer, at least in part, as a function of an order placed on behalf of the second customer.

5. The apparatus of claim 1 wherein the control circuit is configured to determine the need to deliver the particular product to the second customer, at least in part, as a function of:
information including a plurality of partiality vectors for the second customer; and
vectorized characterizations for each of a plurality of products, wherein each of the vectorized characterizations indicates a measure regarding an extent to which a corresponding one of the products accords with a corresponding one of the plurality of partiality vectors.

6. The apparatus of claim 5 wherein the partiality vectors include at least one partiality vector that is knowingly based upon at least one value of the second customer.

7. The apparatus of claim 6 wherein the at least one partiality vector that is knowingly based upon at least one value of the second customer is not based upon any previous purchase of the second customer.

8. The apparatus of claim 1 wherein the control circuit is configured to arrange to transfer the particular product from the enterprise-accessible customer locker to the second customer by automatically tasking a delivery agent with transferring the particular product.

9. The apparatus of claim 8 wherein tasking the delivery agent comprises automatically sending a message to so task the delivery agent.

10. The apparatus of claim 9 wherein the message includes information to unlock the enterprise-accessible customer locker.

11. The apparatus of claim 8 wherein the delivery agent is a third party with respect to the enterprise.

12. The apparatus of claim 8 wherein the delivery agent comprises an autonomous delivery agent.

13. The apparatus of claim 1 wherein the control circuit is further configured to:
determine that the particular product is presently available at the enterprise-accessible customer locker.

14. The apparatus of claim 13 wherein the control circuit is further configured to:
determine that the customer will not likely need the particular product for at least a predetermined period of time.

15. The apparatus of claim 14 wherein the control circuit is further configured to determine that the customer will not likely need the particular product for at least the predetermined period of time as a function, at least in part, of:
information including a plurality of partiality vectors for the customer; and
vectorized characterizations for the particular product, wherein each of the vectorized characterizations indicates a measure regarding an extent to which the particular product accords with a corresponding one of the plurality of partiality vectors.

16. The apparatus of claim 13 wherein the control circuit is further configured to:
arrange for a replacement product for the particular product to be placed in the enterprise-accessible customer locker prior to when the customer will likely need the particular product.
